(19) United States
(12) Patent Application Publication
(10) Pub. No.: US 2026/0062191 A1
(43) Pub. Date: Mar. 5, 2026

(54) Liquid Carrying Container Particularly Suited For Use By Military Personel

(71) Applicant: Tactical H20 Company LLC, Salt Lake City, UT (US)

(72) Inventors: R. Clay Groesbeck, Millcreek, UT (US); Daniel G. Schilling, Holladay, UT (US); Brian Beringer, South Elgin, IL (US)

(21) Appl. No.: 18/821,863

(22) Filed: Aug. 30, 2024

(51) Int. Cl. B65D 75/58; B65D 47/12; B65D 47/24; B65D 65/38; B65D 75/26; B65D 75/30

(52) U.S. Cl. CPC B65D 75/5883; B65D 47/12; B65D 47/243; B65D 65/38; B65D 75/26; B65D 75/30; B65D 2565/387; B65D 2575/583

(57) ABSTRACT

A liquid carrying container particularly suited for military use can be sized and configured to easily fit into the pockets or pouches of military uniforms, tactical gear, and other gear, such as flight suits, or into an ammunition magazine holder, which are specifically provided for holding equipment and supplies which require easy one handed access. The container is substantially shape retaining and has a bottom edge. The container includes a container closure having a push-pull element and a protective over cap. The closure maintains a fixed position with respect to the container so when retrieved by a user with one hand always opens in the same direction without the user needing to see the retrieved container. The container can supply liquid to a tube extending from a face mask using an adapter that connects a face mask tube valve to the push-pull element of the container closure.

### BACKGROUND OF THE INVENTION

### Field

The invention is in the field of portable personal liquid carrying containers such as water bottles, canteens, and beverage pouches, particularly as suited for use by active military personnel.

### State of the Art

The inventors have found that currently available portable liquid carrying containers such as beverage pouches, canteens, and water bottles are difficult to be used by many active military personnel. For example, water bottles and canteens are substantially rigid and are difficult to carry although there are water bottle and canteen carriers in camouflage materials designed to be attached to military packs and uniforms. However, such carriers are difficult to reach to remove and replace the water bottles or canteens in such carriers. It usually requires two hands and various body movements to reach and remove a water bottle or canteen from such holders and to replace the water bottle or canteen back into such holders. Further, water bottles and canteens usually have bottle closures which require two hands to open and close a discharge spout for drinking from such bottles and canteens. One hand is usually required to hold the bottle or canteen and the other hand is required to open and close the closure. This is difficult for active military personal to manage while performing maneuvers or when in a combat situation. In such situations active military personnel do not have two hands free to reach and remove a water bottle or canteen or to open closures on water bottles or canteens. In addition, it is difficult under many conditions to keep the outside of the closure which contacts the user's lips clean and dirt and dust free. Further, water bottles and canteens are generally reused and need to be opened, cleaned, and refilled after being emptied during use.

Beverage pouches, which have become popular with civilians for carrying drinking liquids, are flexible but still have to be carried in back packs or additional carrying pouches so are difficult to reach and remove and difficult to replace. Further, such beverage pouches use discharge closures similar to those in water bottles which require two hands to open, one hand to hold the pouch and one hand to open and close the discharge closure. As indicated, in many situations active military personnel do not have two hands available to find and remove such beverage pouches from their carrying location or to open and close the pouch discharge closure to allow for drinking. Further, such packs, like canteens, have to be opened, cleaned, and refilled after they are emptied during use.

Further, in many situations active military personnel have to be extremely careful to be quiet and not to be seen. Thus, a drinking container for use in such situations should be as quiet as possible to use. Water bottles and canteens can make unwanted noise such as with the beverage in a water bottle or canteen type container sloshing around in the container or with any container that can crinkle when held, squeezed, or when deflated as liquid is taken from the container. Further, such drinking containers should be nonreflective to minimize light reflection as the container is held and used.

Most active military personnel wear military uniforms, tactical gear and other gear, such as flight suits, which include pockets or pouches specifically provided for equipment and supplies which require easy one handed access. For example, most active firearm carrying military soldiers carry extra magazines of ammunition with them, generally in an ammunition magazine carrier specifically designed to carry such a magazine or in uniforms or tactical gear having special pockets or pouches specifically provided for carrying such magazines. Since during battle an extra magazine may be urgently needed, such ammunition magazine carriers are worn by the soldier in very accessible locations in their gear so that the additional ammunition for the weapons they are carrying is easily and quickly available if and when needed and can easily be retrieved from such locations with a single hand. Usually such ammunition magazine carriers or the pockets or pouches provided for carrying such ammunition magazines are designed to hold several magazines, such as three or more magazines, so that usually all of the magazines are not needed.

In some situations, such as for personnel dealing with or in Chemical, Biological, Radiological, Nuclear, and Explosive Environments (CBRNE), such personnel wear protective face masks that do not have openings that allow the discharge spout of a water container to be placed in such person's mouth. Many of the face masks used by such personnel incorporate a tube extending therefrom which can be connected to a liquid source to supply liquid to the person wearing such face mask. Again, however, such water source has to be easily carried by and reached by the user and be easily connected to the tube extending from the face mask. Currently such personnel will use a canteen or a liquid carrying pack, such as Camelbak® pack, that can be attached to the tube extending from the face masks. However, canteens are substantially rigid and hard to carry and have to be held above the user's mouth in order to be drunk from and liquid carrying packs are generally relatively large, heavy, and bulky, and can interfere with the duties and actions of the user. Usually such packs will be worn and carried on a full time basis.

### SUMMARY OF THE INVENTION

According to the invention, a liquid carrying container can be sized and configured to easily fit into the pockets or pouches of military uniforms, tactical gear, and other gear, such as flight suits, which are specifically provided for holding equipment and supplies which require easy one handed access, or to easily fit into an ammunition magazine holder or other holder which may be carried by active duty military personnel. When so sized and configured, the liquid carrying container can be easily reached and removed from and replaced back into the pocket, pouch, ammunition magazine holder, or other holder with one hand of the user. Further, the liquid carrying container of the invention includes a discharge closure device which can be easily opened and closed by a user with one hand, i.e., the one hand holding the liquid carrying container, or by the user's mouth or teeth, thus leaving one hand free for performing the user's other duties. The closure device is provided with a predetermined fixed alignment and orientation with respect to the liquid carrying compartment of the liquid carrying container so that it is in the same position with respect to the liquid carrying compartment when the liquid carrying container is accessed by the user. Also, while the liquid carrying container is made from a flexible plastic material which can be easily handled and squeezed without noise and with minimum or no light reflection, the material used and the liquid carrying container construction provides a substantially shape retaining liquid carrying container that can be easily inserted back into the pocket, pouch, or magazine holder from which it was taken with the one hand holding the liquid carrying container. In addition, the closure device may be adapted to easily mate with a tube extending from a face mask to provide liquid to a person wearing such mask.

In one embodiment of a liquid carrying container of the invention, the liquid carrying container is made a size which approximates the size of an ammunition magazine and of a configuration and strength so as to be easily slid into and out of an ammunition magazine holder or uniform pocket or pouch as currently in use by military personnel which can hold an ammunition magazine, or into and out of a uniform or other gear pocket or pouch. It has been found advantageous for the bottom of the liquid carrying container to form an edge rather than being substantially flat so that the edge will easily slide into the ammunition magazine holder or pocket or pouch without getting stuck or requiring special manipulation with two hands to slide it into and be received by the holder, pocket, or pouch. In addition, the liquid carrying container of the invention is constructed of a soft flexible nonreflecting material so the liquid carrying container is substantially shape retaining but can be bent, squeezed, or collapsed without crinkling and is substantially nonreflecting. A liquid carrying container made of a multilayer flexible material having a food grade layer such as food grade polyethylene forming the inside surface of the liquid carrying container to contact and hold the liquid, a nylon middle layer for strength and to provide an oxygen barrier, and a soft mat finish PET outer layer that can be reverse printed with a camouflage design has been found satisfactory.

The liquid carrying container closure device includes a stem in communication with the inside of the liquid carrying container through which the liquid from the inside of the liquid carrying container is dispensed into a user's mouth, a push-pull element for closing and opening the discharge end of the stem, and a protective over cap covering the stem and push-pull element to protect it from contamination. The protective over cap covering the push-pull element is hingedly attached with respect to the push-pull element so can be rotated from a closed protective position over the push-pull element to an open position to expose the push-pull element and allow drinking. When finished drinking, the protective over cap can be rotated back to the closed position over the push-pull element to protect the push-pull element. The closure device includes an attachment portion which is attached in the liquid carrying container in a manner that aligns the closure device in a specific orientation in the liquid carrying container. The attachment portion may include an elongated surface, such as a canoe portion, which is attached in the liquid carrying container between seams of the liquid carrying container when assembled so that the attachment device is always similarly positioned in the liquid carrying container. In this way, the hinged attachment of the protective over cap is always aligned in a predetermined axis with respect to the liquid carrying container and the holder of the liquid carrying container always knows how to open the protective over cap and gain access to the push-pull element. This means that when the user obtains access to the liquid carrying container and removes the liquid carrying container from the uniform or other gear pocket or pouch or from an ammunition magazine holder with one hand, without looking at the container the user knows how to open the protective over cap and gain access to the push-pull element. This makes the liquid carrying container easily usable in the dark or in other low light conditions, or under conditions where the user has to remain focused on other activities.

The closure device of the invention can be used with various liquid carrying containers, not just the liquid carrying container of the invention. Thus, the invention also provides a larger liquid carrying container that does not necessarily fit into the subject uniform pockets or pouches, or into the ammunition magazine holders, but into larger pockets or pouches or carrying spaces. However, the use of the closure device of the invention, which provides a predetermined fixed alignment of the closure device with respect to the liquid carrying container and provides the protective over cap for protection of the push-pull element, will still provide for easy opening and closing of the closure device by the user while holding the liquid carrying container.

In another aspect of the invention, an adapter is provided for attachment of the end of a face mask tube extending from a face mask such as used by personnel dealing with or in Chemical, Biological, Radiological, Nuclear, and Explosive Environments (CBRNE) to a liquid carrying container having a discharge device with a push-pull element such as provided in the discharge device of the invention. The adapter of the invention includes an adapter body having a receiver at one end of the adapter body to mate with the usual face mask tube connector valve used to connect the end of the face mask tube with a liquid source, and a coupling at the other end of the adapter to mate with a push-pull element of a closure device of a liquid carrying container, such as the push-pull element of the closure device of the invention. The adapter may include an openable protective cover over each end of the adapter or a removable protective plug in each end of the adapter and can include a handle by which the adapter can be manipulated during the connection and disconnection of the adapter to and from the face mask tube connector valve normally provided on the end of the face mask tube and to and from the connection to the push-pull element of the liquid carrying container. The handle can also be used to move the adapter to open and close the push-pull element to which it is attached of the liquid carrying container closure. The use of a liquid carrying container such as the liquid carrying container of the invention frees the person wearing the face mask from carrying a bulky rigid canteen or water bottle which needs to be held over the user's head to drink from or from wearing a full time bulky pack type liquid reservoir and frees the user to use small easy to carry portable water containers such as those of the invention when liquid is needed for hydration. Further, the liquid carrying containers of the invention are designed for short term use, i.e., for use until the liquid in the liquid carrying container is substantially used, and to be discarded after such use.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a perspective view of an empty liquid carrying container of the invention with a portion of the top of the liquid carrying compartment broken away to show attachment of the liquid carrying container closure device to the liquid carrying compartment and showing the liquid carrying container closure device parts in exploded view.

FIG. 2 is a perspective view similar to that of FIG. 1 showing the liquid carrying container closure device in assembled condition;

FIG. 3 is a right side elevation of the empty liquid carrying container of FIG. 2 with the sides edges together against each other.

FIG. 4 is a right side elevation of the liquid carrying container of FIG. 2 in a filled condition.

FIG. 5 is a perspective view of a filled liquid carrying container.

FIG. 6 is a perspective view of a piece of material used to form the gussets in the construction of the liquid carrying containers of FIGS. 1-5.

FIG. 7 is a vertical section taken on the line 7-7 of FIG. 2.

FIG. 8A is a perspective view similar to that of FIG. 5 but showing an empty container having the side facing the viewer pushed apart and taken from a position more above the liquid carrying container.

FIG. 8B is a longitudinal section taken on the line 8B-8B of FIG. 8A.

FIG. 9 is an enlarged exploded view in perspective of the closure device of the invention as shown in FIG. 1 but without the liquid carrying compartment being shown.

FIG. 10 is an exploded view in perspective of the closure device of the invention with the push-pull element of the closure device assembled to the stem of the device.

FIG. 11 is a perspective view of the closure device with the protective over cap assembled to the device.

FIG. 12 is a front view of the closure device of FIG. 11.

FIG. 13 is a left side view of the closure device of FIG. 11.

FIG. 14 is a rear view of the closure device of FIG. 11.

FIG. 15 is a top view of the closure device of FIG. 11.

FIG. 16 is a bottom view of the closure device of FIG. 11.

FIG. 17A is a vertical section taken on the line 17A-17A of FIG. 12 and which shows the push-pull element in closed condition.

FIG. 17B is a vertical section similar to that of FIG. 17A, but showing the protective over cap rotated to a partially open position to the side of the closure device to expose the push-pull element of the closure device, with arrows showing the rotation moving the protective over cap into the open position and showing how the protective over cap can be rotated into the open position by the teeth of a user.

FIG. 17C is a vertical section similar to that of FIG. 17B, but showing the protective over cap rotated to a fully open position to provide full access to the push-pull element.

FIG. 17D is a vertical section similar to that of FIG. 17C but showing the push-pull element pulled upwardly along the stem to an open condition, and also showing how the push-pull element can be pulled upwardly along the stem by the teeth of a user.

FIG. 17E is an enlarged view taken on the line 17E-G of FIG. 17D showing the push-pull element higher on the stem before full assembly of the push-pull element on the stem and showing the relative positions of the inwardly projecting ring of the push-pull element and the outwardly extending flange at the top of the stem.

FIG. 17F is an enlarged view taken on the line 17E-G of FIG. 17D showing the push-pull element moved downwardly on the stem but before being fully assembled on the stem.

FIG. 17G is an enlarged view taken on the line 17E-G of FIG. 17D showing the push-pull element moved more downwardly to be fully assembled on the stem and in open position on the stem as shown in FIG. 17D.

FIG. 18A is a side elevation of an ammunition magazine.

FIG. 18B is a side elevation of a liquid carrying container of the invention showing the outline of the ammunition magazine of FIG. 18A in broken lines behind the liquid carrying container.

FIG. 19A shows a user holding a liquid carrying container of the invention in a single hand of the user and the user rotating the protective over cap to an open position with the user's teeth to expose the push-pull element of the closure device.

FIG. 19B shows a user holding a liquid carrying container of the invention in a single hand of the user as shown in FIG. 19A and with the protective over cap rotated to the position shown in FIG. 19A to expose the push-pull element and the user using the user's teeth to pull the push-pull element to the open position.

FIG. 20 shows a user holding a liquid carrying container of the invention in a single hand of the user and the user rotating the protective over cap of the closure device to the open position with the thumb of the user's hand.

FIG. 21 is a view of a sheet of camouflage material which can be used to create a liquid carrying container of the invention in a camouflage pattern.

FIG. 22 is an exploded view in perspective of a second embodiment of the closure device of the invention with the push-pull element of the closure device assembled to the stem of the device and having an additional ring extending outwardly from the push-pull element.

FIG. 23 is a perspective view of the closure device of FIG. 22 with the protective over cap assembled to the device over the push-pull element and showing the additional ring extending outwardly from the push-pull element in broken lines.

FIG. 24 is an exploded view of an adapter for attachment to the push-pull element of the closure device where the adapter is used to attach the liquid carrying container to the end of a face mask tube extending from a protective face mask or other face covering.

FIG. 25 is an elevation of an assembled adapter of FIG. 24.

FIG. 26 is a perspective view of the adapter of FIG. 25 attached to the push-pull element of the closure device of the invention extending from a second embodiment liquid carrying container, and showing a showing a face mask tube connector valve ready to be attach to the adapter.

FIG. 27 is a perspective view taken from the outlet end and above a second embodiment of an adapter for attachment to the push-pull element of the closure device used to attach the liquid carrying container to the end of a face mask tube extending from a protective face mask or other face covering and showing the end caps open.

FIG. 28 is a perspective view taken from the inlet end (opposite end) and below the adapter as shown in FIG. 27.

FIG. 29 is a perspective view taken from the inlet end (opposite end) and above the adapter as shown in FIG. 27 and showing the end caps closed.

FIG. 30 is a perspective view taken from the outlet end and above the adapter as shown in FIG. 27 and showing the end caps closed.

FIG. 31 is a side view of the adapter as shown in FIG. 27.

FIG. 32 is a side view from the opposite side of the adapter as shown in FIGS. 27 and 31.

FIG. 33 is a top view of the adapter as shown in FIG. 31.

FIG. 34 is a bottom view of the adapter as shown in FIG. 31.

FIG. 35 is an inlet end (left side) view of the adapter as shown in FIG. 31.

FIG. 36 is an outlet end (right side) view of the adapter as shown in FIG. 31.

FIG. 37A is a longitudinal section through the second embodiment adapter as shown in FIGS. 27-36 showing the adapter attached to the push-pull element of the liquid carrying compartment closure with the push-pull element in closed position, and showing a face mask tube connector valve ready to be inserted into the liquid outlet of the adapter.

FIG. 37B is a longitudinal section similar to that of FIG. 36 but showing the face mask tube connector valve inserted into the liquid outlet of the adapter and showing the push-pull element in open position.

FIG. 38A is an exploded view of the second embodiment adapter ready to be connected to the push-pull element of a liquid carrying compartment closure of a liquid carrying container and ready to be connected to a face mask tube connector valve.

FIG. 38B is an exploded view similar to that of FIG. 38A showing the adapter connected to the push-pull element of the liquid carrying compartment closure of the liquid carrying container.

FIG. 38C is an exploded view similar to that of FIG. 38B showing the adapter connected to the face mask tube connector valve.

FIG. 39 shows a user with a face mask holding the liquid carrying container of FIGS. 38A-38C with a face mask tube extending from the face mask and having a face mask tube connector valve at the end of the tube which face mask tube connector valve is attached through the adapter of FIGS. 27-36 to the closure device of the liquid carrying container and shows the user squeezing the liquid carrying compartment of the liquid carrying container to supply drinking liquid to the user.

### DETAILED DESCRIPTION OF THE ILLUSTRATED EMBODIMENTS

In one aspect, the invention provides a liquid carrying container for carrying liquids such as water or other beverages for drinking. The invention can provide such a liquid carrying container that is specifically configured to be carried by active military personal and other active people in pockets or other carriers, such as ammunition magazine carriers, that are easily accessible by a user with a single hand of the user and which liquid carrying container is easily removed from the carrying location with and is easily replaced in the carrying location with the single hand of the user. In another aspect, the invention provides a closure device for a liquid carrying container which aligns the closure device in a desired expected position with respect to the liquid carrying container. When used with a liquid carrying container of the invention designed for one handed use, the closure device of the invention provides a known alignment of the closure device with respected to the liquid carrying container. This allows reliable operation of the closure device by the user holding the liquid carrying container in the single hand of the user that accessed the liquid carrying container from the carrying location. The closure of the invention in combination with the liquid carrying container of the invention allows for the single handed use of the liquid carrying container. The closure of the invention can also maintains all parts of the closure attached to the closure. In a still further aspect, the invention provides an adapter for connecting a hydration tube extending from a face mask to a closure device of a liquid containing carrying container.

The term liquid as used herein is not limited to freely flowing liquids such as water, but to viscous liquids that can flow through the components of the liquid carrying container and the compartment closure either freely or with some pressure applied to the viscous liquids such as by squeezing the liquid carrying container. Such liquids may be nutritious semiliquid foods such as gels or go-gurt type products that can be squeezed from tubes or squeezable packages.

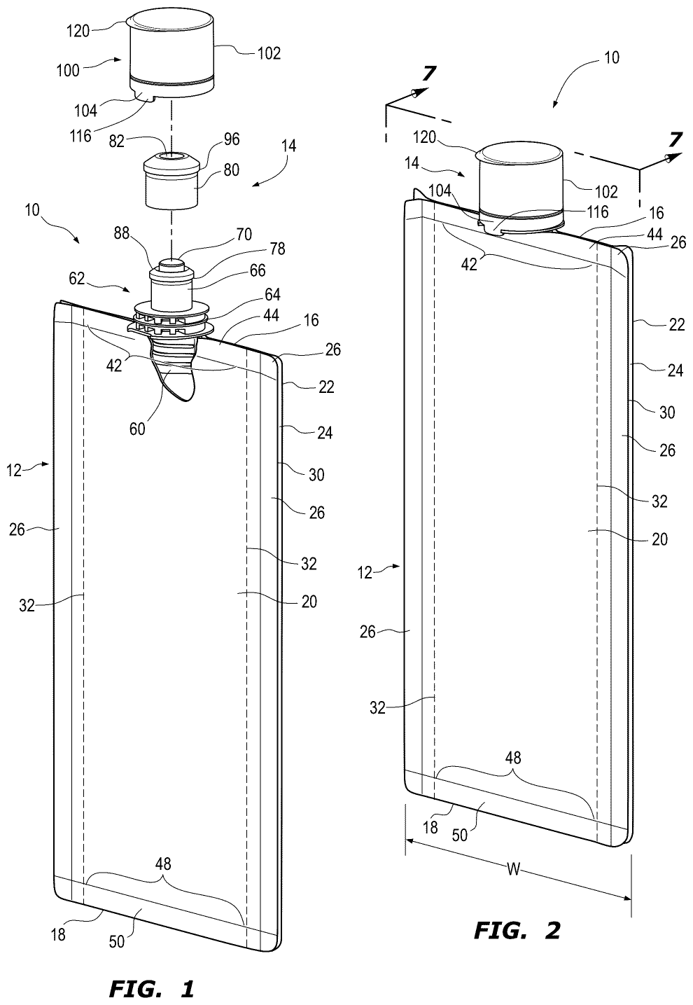

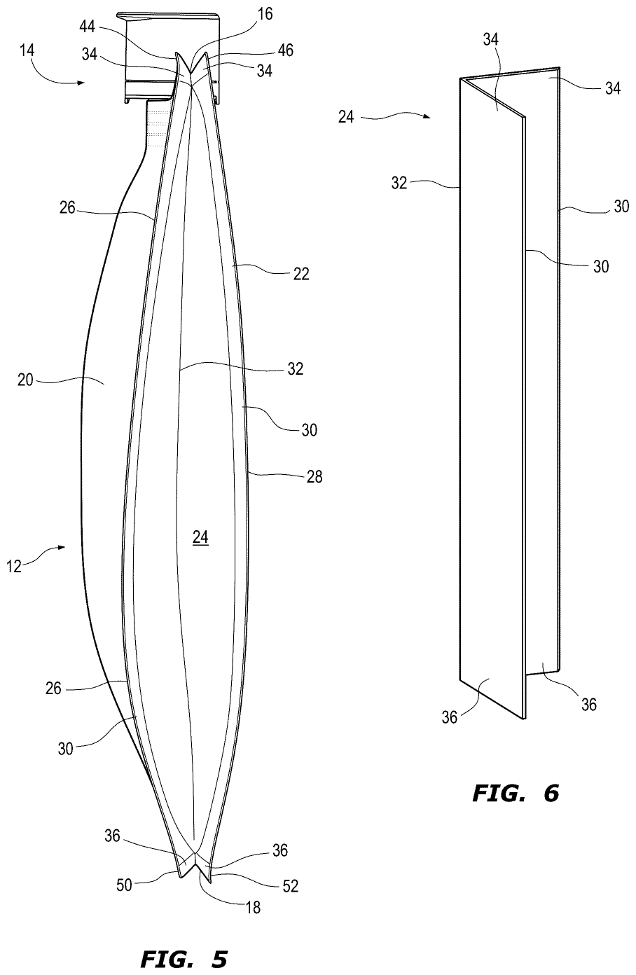

FIGS. 1-5 and 7-8A show an example of one embodiment of liquid carrying container 10 of the invention. The liquid carrying container 10 includes a liquid carrying compartment 12 and a compartment closure device 14 extending from the top edge 16 of the liquid carrying compartment 12. FIGS. 1, 2, and 3 show the container in an empty condition while FIGS. 4 and 5 show the container in a filled condition. The construction of the container is such that the bottom edge 18 of the container maintains a substantially straight edge whether in empty condition or in filled condition.

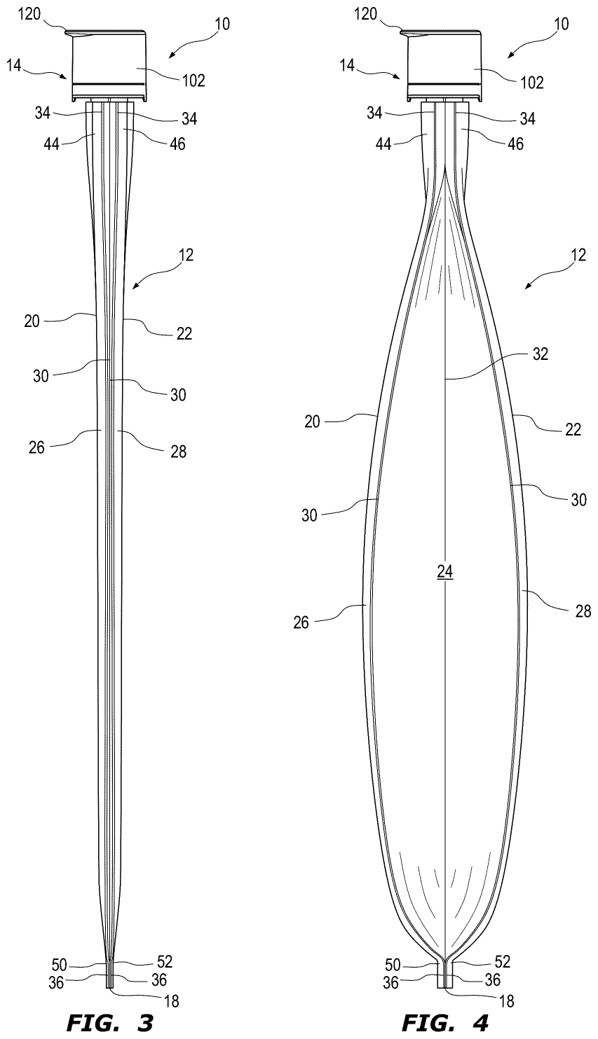

In the construction of this example liquid carrying container 10, the liquid carrying compartment 12 includes a compartment front panel 20 and a compartment back panel 22. Gussets 24 are attached between the front panel 20 and the back panel 22 to form opposite sides of the compartment. Thus, for each of the opposite sides of the liquid carrying compartment, a gusset 24 is sealingly attached along and between the side edge portion 26 of compartment front panel 20 and the side edge portion 28 of compartment back panel 22 to allow the intermediate side portions of the compartment front panel 20 and compartment back panel 22 to separate when the compartment is filled with a liquid as shown in FIGS. 4 and 5. In the particular construction as shown, each of the gussets 24 are rectangular pieces of material, FIG. 6, which are folded in half lengthwise to form opposite gusset side edge portions 30, a gusset fold line 32, a gusset top edge portion 34, and a gusset bottom edge portion 36. To form a side of the compartment 12, opposite gusset side edge portions 30 of a gusset piece are sealingly secured along a compartment front panel side edge portion 26 and a compartment back panel side edge portion 28 at one side of the compartment. With the opposite side edge portions 30 of a gusset piece attached along the side edge portions 26 and 28 of the compartment front and back panels 20 and 22, the folded gusset pieces will extend inwardly from the compartment side edge toward the center of the compartment along the compartment top edge 16 and the compartment bottom edge 18 the distance from the gusset side edge portions 30 to the gusset fold line 32. The top edge portion 34 of the gusset that extends inwardly along the top edge 16 of the front panel 20 of the compartment is sealingly attached along the top edge portion 44 of the front panel 20. The top edge portion 34 of the gusset that extends inwardly along the top edge 16 of the back panel of the of the compartment is sealingly attached along the top edge portion 46 of the back panel, see FIGS. 3-5, and 7. Similarly, the bottom edge portion 36 of the gusset that extends inwardly along the bottom edge 18 of the front panel 20 of the compartment is sealingly attached along the bottom edge portion 50 of the front panel 20. The bottom edge portion 36 of the gusset that extends inwardly along the bottom edge 18 of the back panel of the compartment is sealingly attached along the bottom edge portion 52 of the back panel. The opposite side of the compartment 12 is similarly constructed. While any type of sealing attachment can be used, if the material used for construction of the compartment is a plastic sheet material, the edges can be easily welded together to form a sealed attachment. Such welded attachment of the parts will usually have a width and may have a width of up to about one-quarter inch which is shown in the drawings and which is referred to as being the edge portions of the various parts as described herein.

The distance from the gusset side edge portions 30 to the gusset fold line 32 on each side of the compartment will usually be less than one quarter of the length of the compartment top edge 16 and the compartment bottom edge 18. This provides a top center space 42, FIGS. 1, 2, and 7, along the compartment top edge 16 between the gusset fold lines 32 and between compartment front panel top edge portion 44 and compartment back panel top edge portion 46. Similarly, a bottom center space 48 is provided along the compartment bottom edge 18 between the gusset fold lines 32 and between compartment front panel bottom edge portion 50 and compartment back bottom edge portion 52. The top center space 42 allows the compartment closure device 14 to be sealingly secured within the top center space 42 between the compartment front panel top edge portion 44 and the compartment back panel top edge portion 46 during manufacture of the container. The bottom center space 48 forms a compartment opening which is used to fill the compartment with liquid and which is closed during manufacture of the container after the compartment is filled with liquid by sealingly securing the compartment front panel bottom edge portion 50 to the compartment back panel bottom edge portion 52 along the bottom center space 48.

With this construction of the liquid carrying compartment 12, the liquid carrying compartment 12 will be substantially flat when the liquid carrying compartment is empty with the compartment front panel 20 and compartment back panel 22 substantially together, FIGS. 1, 2, and 3. The gussets 24 may cause the side edges of the compartment to separate slightly as shown in FIGS. 1 and 2, but this is still considered to be substantially flat and substantially together. FIGS. 4 and 5 show the container full. When full, the intermediate portion of the liquid carrying compartment between the top and bottom edge portions will be expanded as shown in FIGS. 4 and 5, with the gussets 24 forming the filled liquid carrying compartment opposite sides. The intermediate portion of the liquid carrying compartment between the top and bottom edge portions will move toward one another as the liquid carrying compartment is emptied. These front and back panels can be squeezed together to force liquid from the filled or partially filled compartment when the compartment closure is opened, or the liquid can be sucked by the user out of the container causing the container to collapse. Alternately, the liquid carrying container can be lifted above the user's mouth and turned with the compartment closure pointing downwardly so the liquid in the liquid carrying compartment will flow out of the liquid carrying container by gravity. However, even when full, the top and bottom edges of the compartment remain substantially straight and together.

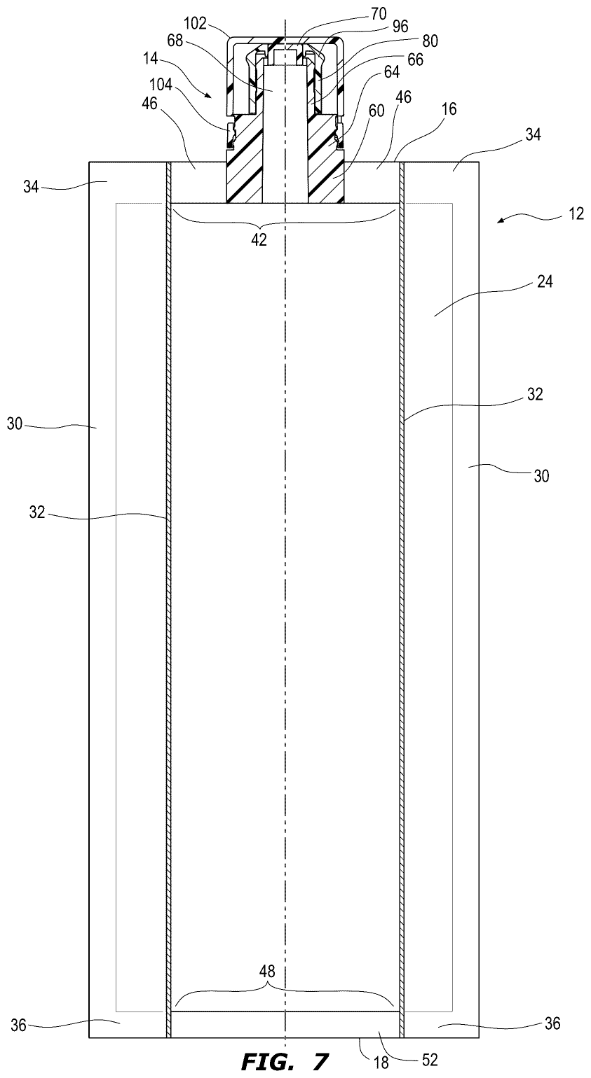

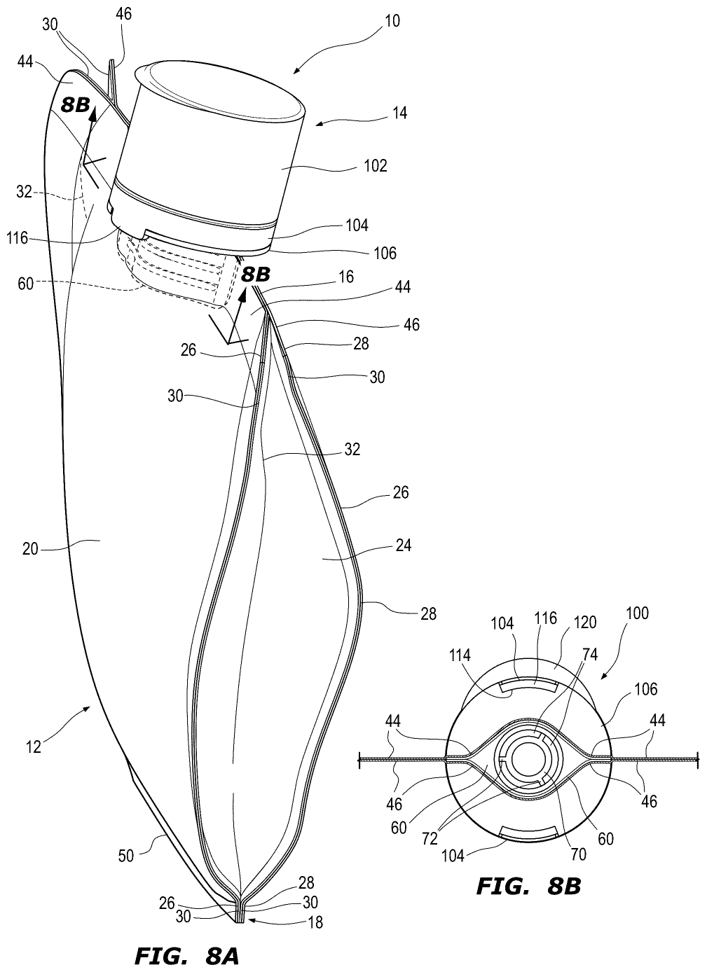

FIG. 8A shows the compartment empty but with the side of the compartment facing the viewer pushed apart to more clearly show the compartment construction. The side portions of the compartment front panel 20 and compartment back panel 22 have been pushed apart to show the securement of the gusset side portions 30 to the compartment front panel side portion 26 and the compartment back panel side portion 28. The side of the compartment facing away from the viewer shows substantially the normal positions of the side portions of the compartment when empty. Without pushing the sides of the compartment apart as shown for the side of the compartment facing the viewer in FIG. 8A, the sides of the compartment on each side of the compartment would remain substantially together as shown in FIGS. 1-3 when the compartment is empty. FIG. 8A shows in broken lines an elongate canoe portion 60 of the compartment closure 14 and FIGS. 8A and 8B show that the canoe portion 60 of the compartment closure 14 is sealingly secured between the compartment front panel top edge portion 44 and compartment back panel top edge portion 46 in the center portion of the top center space 42 of the compartment along the compartment top edge 16 between the gusset fold lines 32 on each side of the compartment. With this attachment of the elongate canoe portion 60 of the compartment closure 14 between the top edges of the compartment front panel and back panel, the elongate axis of the canoe portion 60 will always be aligned with the width W of the compartment. FIGS. 7, 8A, and 8B also show that the top edge portion 44 of compartment front panel 20 and top edge portion 46 of back panel 22 are sealingly secured directly together between respective ends of the canoe portion 60 and respective gusset fold lines 32. FIGS. 5, 7, and 8A show that only the portions of the top edge of the compartment along the gussets can be separated, even when pushed apart as shown in FIG. 8A. Also, since the bottom edge portion 50 of compartment front panel 20 and bottom edge portion 52 of back panel 22 are sealingly secured directly together along the bottom center space 48 between the gusset fold lines 32, only the portions of the bottom edge of the compartment along the gussets can be separated, even when pushed apart. With this construction, the top and bottom edge portions of the compartment will remain substantially flat and substantially straight with the compartment front panel and compartment back panel top and bottom portions of the liquid carrying compartment substantially together even when the liquid carrying compartment is full or partially full. This bottom edge 18 of the liquid carrying compartment allows a full or partially full liquid carrying compartment to be easily slipped into a uniform or gear pocket or an ammunition magazine container.

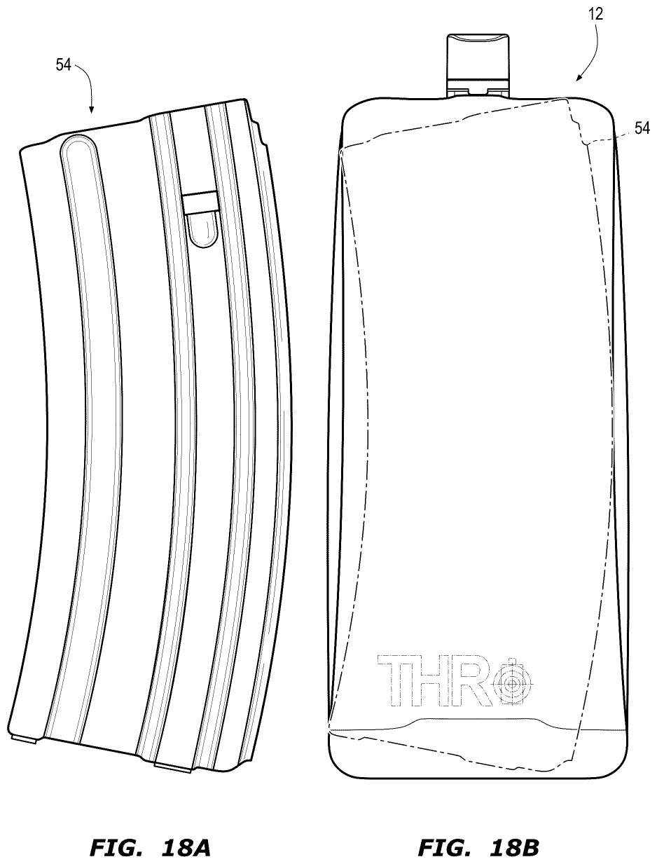

To allow the liquid carrying compartment to be easily slipped into a uniform or gear pocket or an ammunition magazine carrier, the liquid carrying compartment must be sized with a width W, FIG. 2, less than the width of the uniform or gear pocket or the ammunition magazine carrier. A liquid carrying compartment width of about three (3) inches has been found as a satisfactory width for fitting into most uniform or gear pockets or ammunition magazine carriers. FIG. 18A shows a common ammunition magazine 54. An example of a liquid carrying container 12 of the invention is shown in FIG. 18B. The ammunition magazine 54 shown in FIG. 18A is shown in broken lines behind the liquid carrying container shown in FIG. 18B. The thickness of the liquid carrying container is also made similar to the thickness of the ammunition magazine at about one inch. A height of the liquid carrying compartment 12 of the liquid carrying container 10 of about seven and one quarter inches, and total height of the liquid carrying container 10 with the compartment closure 14 extending from the top of the liquid carrying compartment 12 of about eight and one eighth inches has been found satisfactory. The example liquid carrying container that is sized similarly to the ammunition magazine will fit into a uniform or gear pocket or ammunition carrier similarly as would the ammunition magazine. Further, with the substantially flat straight edge bottom 18 as previously described, the liquid carrying container of FIG. 18B can easily be slipped into the uniform or gear pocket or ammunition magazine carrier by a user with a single hand holding the liquid carrying container. A liquid carrying compartment sized as described above will usually hold about 230 or so milliliters of liquid (almost 8 ounces of liquid).

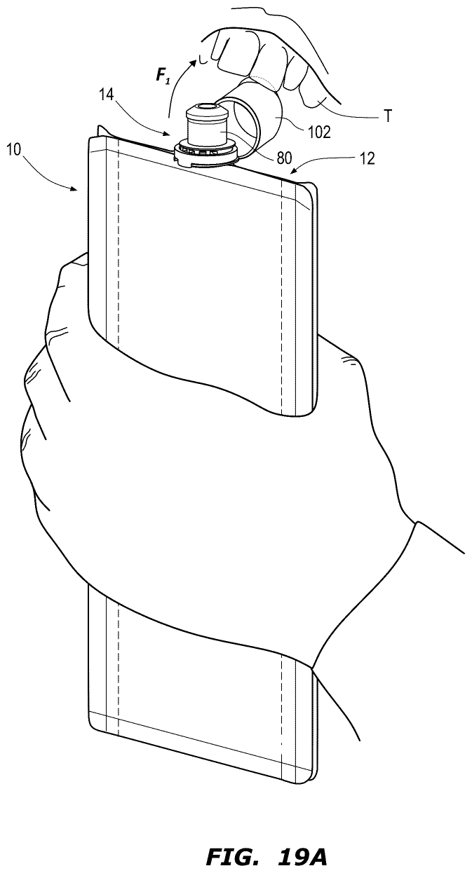

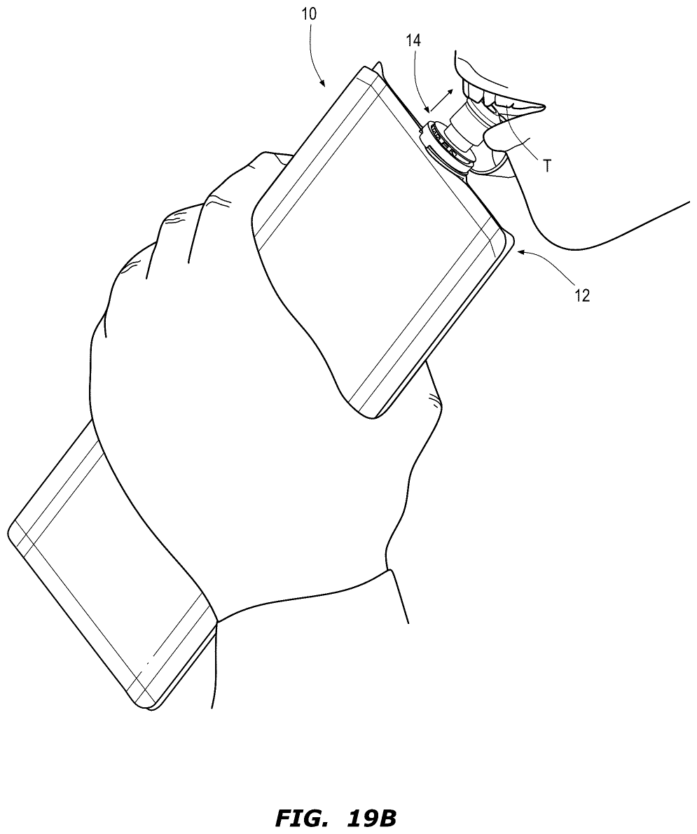

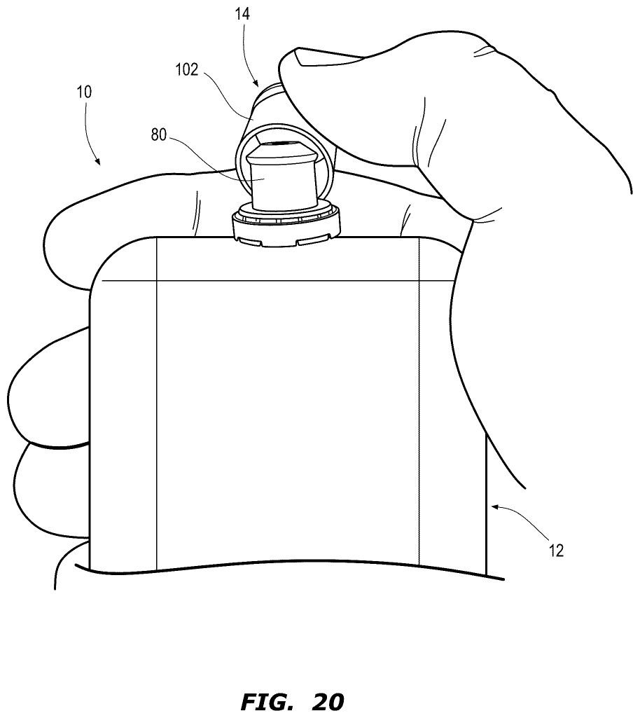

In addition, with the width W of the liquid carrying container greater than the thickness of the liquid carrying container and the height greater than the width as shown, a user will generally easily grab and hold the liquid carrying container oriented with the width in the user's palm as shown in FIGS. 19A and 19B, or alternatively as shown in FIG. 20. Further, a marking or graphics on the container, or a structural feature of the container, can indicate a front side and a back side of the container so the user can initially orient the container in the user's receiving uniform or gear pocket or ammunition magazine carrier in a predetermined orientation. In this way, the liquid carrying container can always be removed from the user's receiving uniform or gear pocket or ammunition magazine carrier to be held by a user in a known orientation in the user's hand. It is not necessary that the user be able to see the liquid carrying container to know its orientation. Thus, the user can remove the liquid carrying container from the user's receiving uniform or gear pocket or ammunition magazine carrier with one hand without seeing the liquid carrying container, such as in the dark, under low light conditions, or when the user has to keep his or her eyes focused on other things, and without looking at the liquid carrying container be able to open and drink from such container, and to close and return the liquid carrying container to the user's receiving uniform or gear pocket or ammunition magazine carrier with the same orientation as when removed therefrom.

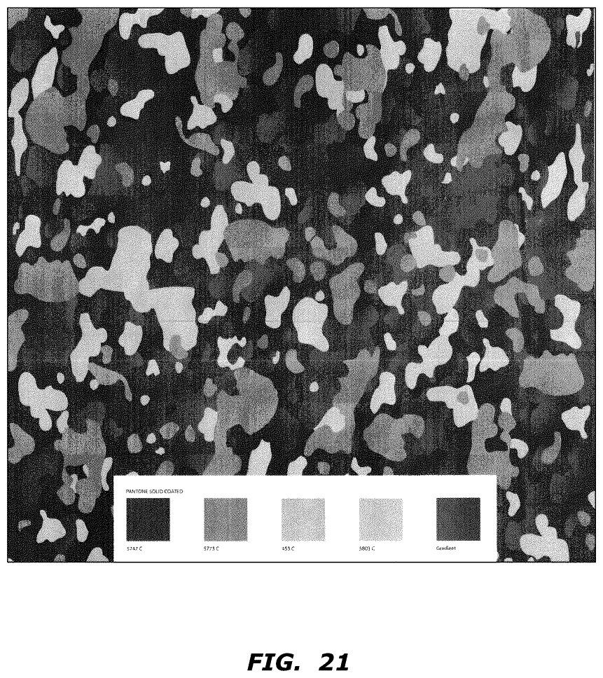

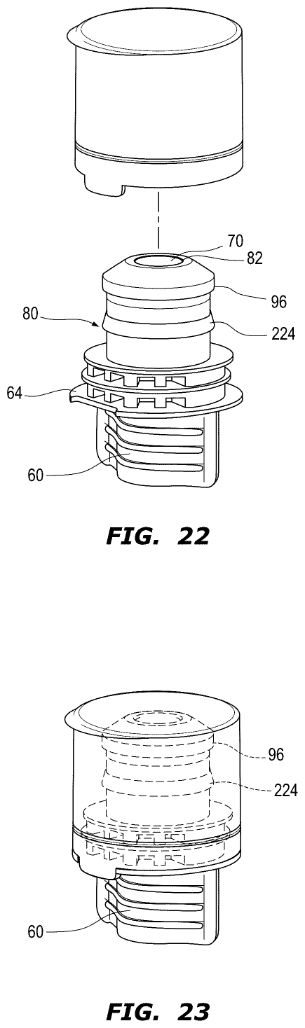

The liquid carrying compartment can be formed of various materials, but since the compartment is designed to hold and carry liquids for drinking, the material should be of a food grade. It has been found that a multilayer soft and flexible plastic laminate material having a food grade inner layer is satisfactory. In particular, a laminate three layer material having an inner layer of food grade polyethylene to protect the liquid, a middle layer of nylon material to provide strength and an oxygen barrier, and an outer layer of a flexible soft matte PET material that can be reverse printed to reduce light reflection and can be bent without crinkling is a satisfactory material. Such material, while flexible, should be selected so that when formed into the liquid carrying container, forms a substantially shape retaining liquid carrying container that can be easily slipped into a receiving uniform or gear pocket or ammunition magazine carrier. An advantage of reverse printing the outer layer of material is that the printing, such as a camouflage pattern, has low light reflection properties and is protected from scratching and wear so remains effective during use of the liquid carrying container. Since the liquid carrying container of the invention is particularly suited for military use, the material used to build the container may have a camouflage design so as to be less noticeable during use. FIG. 21 shows a camouflage pattern that can be reverse printed on the outer layer of the flexible soft matte PET material. This pattern can be printed in several different color combinations depending upon the time of year and the area where the liquid carrying containers are going to be used. Various colors that can be used are shown on the color patches along the bottom of the pattern shown in FIG. 21 and the color patches, while not shown in color, have indications of the particular Pantone colors represented.

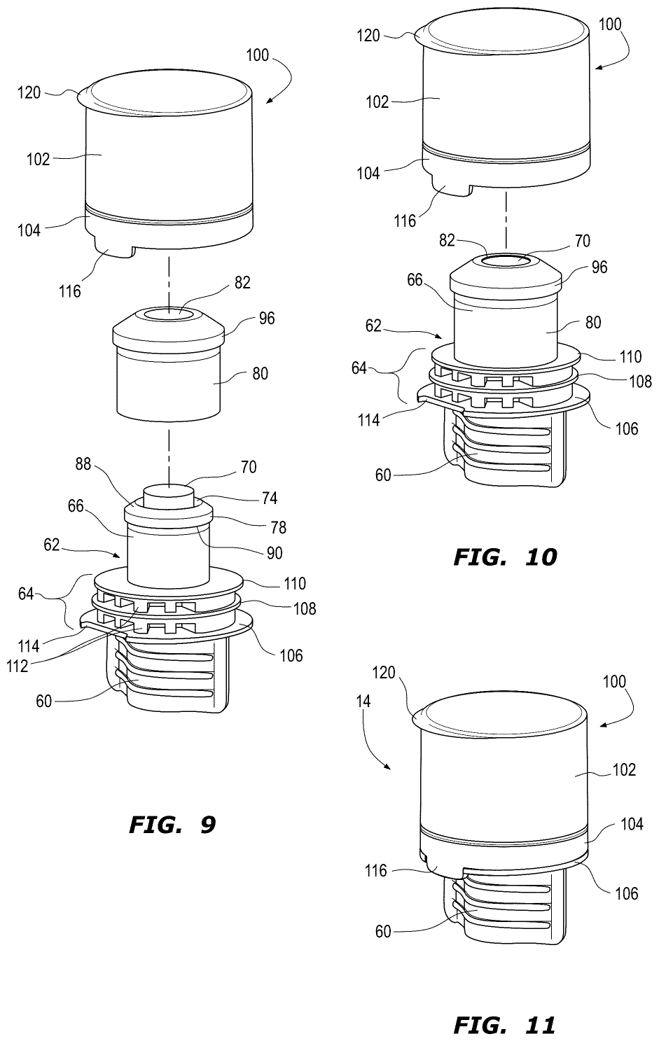

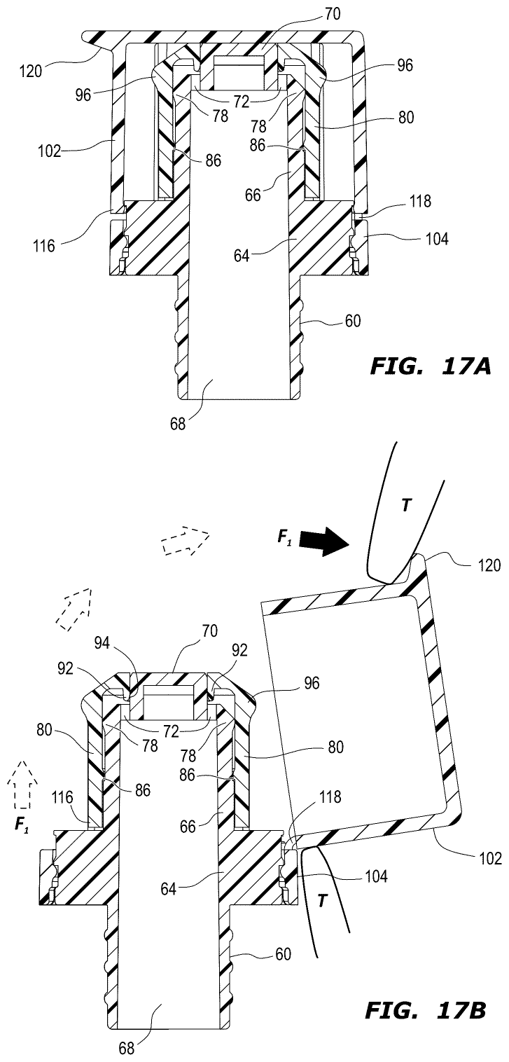

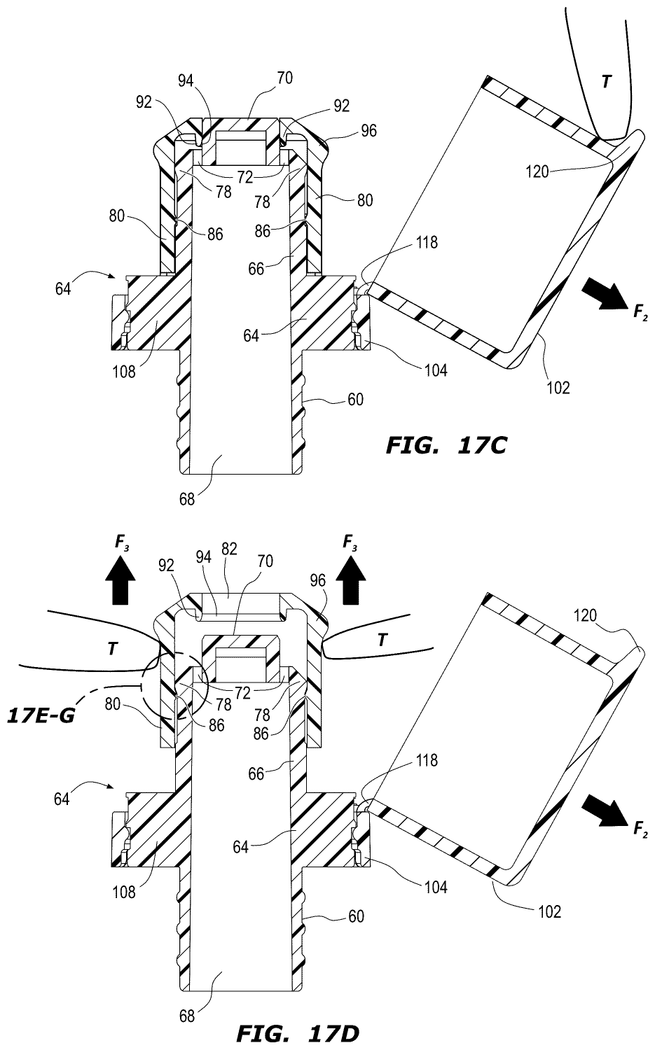

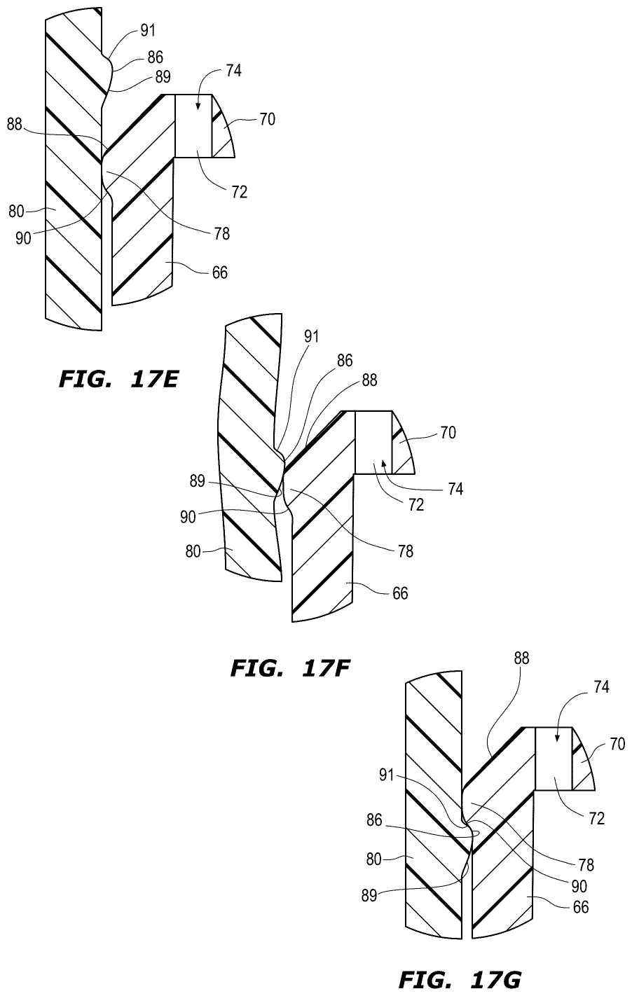

The compartment closure 14 of the invention is designed to have a specific orientation with respect to the container so that it will always open and close with the same orientation. As shown in FIGS. 1, 7, and 9, the compartment closure 14 includes a closure body 62 which includes the elongate canoe portion 60, FIGS. 9-11, which is sealed into the center portion of the top center space 42 of the top edge 16, FIGS. 1, 7, 8A and 8B, of the liquid carrying compartment 12. A closure body spacer portion 64, FIGS. 7 and 9, extends from the closure body canoe portion 60 to a closure body stem portion 66. A passage 68, FIGS. 7 and 17A-17D, extends through stem portion 66, spacer portion 64, and canoe portion 60 to inside the liquid carrying compartment 12. A passage center plug 70, FIGS. 1, 7, 8B, 9, 10, 16, and 17A-17D, is attached in the end of closure body stem portion 66 by legs 72, FIGS. 8B, 16, and 17A-17D, secured in the end of the body stem portion 66. Such passage center plug 70, legs 72, and stem portion 66 may be molded as part of plug body portion 62. The center plug 70 is positioned in the center of the end of the passage 68 with the securing legs 72 forming openings 74 for the passage 68 between the inner sides of the stem portion 66 and the center plug 70 to allow liquid from inside liquid carrying compartment 12 to flow from the liquid carrying compartment 12 through passage 68 and out the end of passage 68 through openings 74 around center plug 70. The end of body stem portion 66 includes a flange 78.

A push-pull element 80 is mounted for sliding movement on stem portion 66 and fits snugly, but slidingly, over flange 78 at the end of the stem portion 66. The end of push-pull element 80 has a central opening 82. Central opening 82 is adapted to receive center plug 70 snugly therein when push-pull element 80 is pushed to a closed position, FIGS. 7, 10, 17A, 17B, and 17C. In this closed position, passage 68 is blocked so no liquid can flow through passage 68 from liquid carrying compartment 12. Push-pull element 80 can be slid upwardly along stem portion 66 away from the closed position as shown in FIGS. 17A-17C to an open position shown in FIG. 17D to provide space for liquid to flow between center plug 70 and push-pull element center opening 82 to allow fluid to flow from liquid carrying compartment 12 through passage 68 and openings 74, and around center plug 70 and out of push-pull element central opening 82. A small ring 86, FIGS. 17A-17G, molded onto the inside of push-pull element 80 is forced over stem portion flange 78 during assembly of the compartment closure 14. The top of this ring 86 will then abut the lower surface of stem flange 78 to block removal of push-pull element 80 when push-pull element 80 is moved from closed position to fully open position, FIGS. 17D and 17G. It should be noted that the upper surface 88 of stem portion flange 78 and the lower surface 89 of push-pull element ring 86 may each be sloped to ease movement of ring 86 over flange 78 during assembly of the push-pull element onto stem portion 66. Also, the lower surface 90 of flange 78 is more sharply curved outwardly from the stem portion 66 as is the upper surface 91 of ring 86. This then resists movement of ring 86 back over flange 78 when the push-pull element 80 is pulled upwardly along stem portion 66 when moved to open position when in use, FIG. 17D. FIG. 17E shows the position of push-pull element 80 relative to the stem portion 66 before the push-pull element is pushed into assembled position on stem portion 66. FIG. 17F shows the position of push-pull element 80 relative to the stem portion 66 as the push-pull element is starting to be pushed into assembled position on stem portion 66. FIG. 17G shows the position of push-pull element 80 relative to the stem portion 66 after the push-pull element 80 is pushed into assembled position on stem portion 66 and shows how the upper surface 91 of the push-pull element ring 86 abuts the lower surface 90 of the stem portion flange 78 when the push-pull element is in open position. This resists further movement of the push-pull element 80 upwardly along stem portion 66 to resist removal of push-pull element 80 from stem portion 66. Further, this resists flow of liquid between push-pull element ring 86 and stem portion flange 78 when the push-pull element is in open position. Liquid flow is also blocked by the snug fit of push-pull element 80 over flange 78 at the end of the stem portion 66. When the push-pull element 80 is moved to closed position, the push-pull element 80 is pushed downwardly from the open position shown in FIGS. 17D and 17G so the push-pull element ring 86 moves downwardly along stem portion 66 away from stem portion flange 78. It should also be noted as shown in FIGS. 17B, 17C and 17D, that central opening 82 of push-pull element 80 includes a flange 92 around push-pull element central opening 82 extending into the open area inside the push-pull element 80 and which includes a slightly tapered end surface 94, FIG. 17D, which helps passage center plug 70 slide into push-pull element central opening 82 when push-pull element 80 is moved from open position, FIG. 17 D, to closed position, FIGS. 17A-17C. This allows a snug fit which is resistant to liquid passage when the push-pull element is moved to closed position.

The push-pull element 80 forms the drinking spout of the liquid container and includes a flange 96 around the top of push-pull element 80. The push-pull element 80 can be operated by a user's hand or a user's thumb pushing or pulling the push-pull element between open and closed positions. The push-pull element can also be operated by a user's teeth T as shown in FIGS. 17D and 19B. The user can close the user's teeth around flange 96 as shown to pull the push-pull element 80 to open position while holding the liquid container in one hand as shown in FIG. 19B. The user can then close the push-pull element by pushing the push-pull element against the user's teeth, against the user, or against any convenient surface.

In order to prevent contamination of the push-pull element 80 which forms the drinking spout for the liquid carrying container 10, an over cap assembly 100 is provided as part of the compartment closure 14. The over cap assembly 100 is of cylindrical formation with a protective cylindrical over cap 102 hingedly attached to a cylindrical over cap base 104 which is secured to the spacer portion 64 of the closure body 62. As shown, FIGS. 1, 7, 9, 10, and 17A-17D, spacer portion 64 of the closure body 62 includes a bottom disk 106, an intermediate disc 108, and a top disk 110 connected by connector ribs 112. Bottom disk 106 is of greater diameter than intermediate disk 108 and top disk 110 which are of equal diameters. Bottom disk 106 includes at least one cutout, and as illustrated, two cutouts 114 at opposite sides of bottom disc 106 that extend inwardly a distance so that the inner edges of the cutouts substantially match the diameters of the intermediate and top disks. Over cap base 104 fits snugly around and is held in place by intermediate disk 108. Over cap base 104 includes at least one downwardly extending tab, and as illustrated, two downwardly extending tabs 116, which are sized to fit into bottom disk cutouts 114. The purpose of the downwardly extending tabs 116 and the cutouts 114 is to provide a fixed rotational orientation of the over cap assembly with respect to the container closure body 62. As previously described, the container closure body 62 includes the container closure body canoe portion 60 having an elongate axis and which is secured to the liquid carrying container between edges of the container front panel and the container rear panel so that the canoe portion elongate axis is always aligned with the width of the liquid carrying compartment 12 of the liquid carrying container 10. Thus, the liquid carrying container closure body 62 has a fixed known position and orientation with respect to the liquid carrying compartment. This means that the spacer portion 64, spacer portion bottom disk 106, and lower disk cutouts 114 of the closure body 62 also have a fixed known position and orientation with respect to the liquid carrying compartment. Therefore, when downwardly extending tabs 116 of over cap base 104 are inserted into lower disk cutouts 114, over cap base 104 will also have a known fixed position and orientation with respect to the liquid carrying compartment.

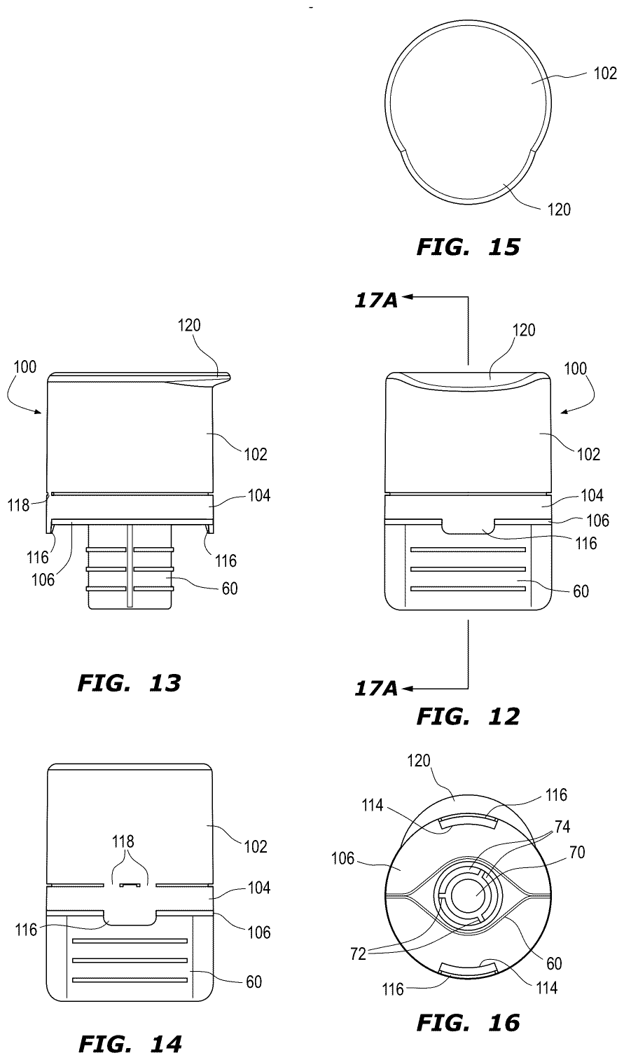

Protective cylindrical over cap 102 has a hinged attachment 118 to over cap base 104, FIGS. 13, 14, and 17A-17D, which hinged attachment has a fixed orientation with respect to the downwardly extending tabs 116, FIGS. 1, 2, 9, 10, 11 13, and 14. Therefore, protective cylindrical over cap 102 will be hinged to over cap base 104 and liquid carrying container 10 so that it always opens and closes with a known orientation with respect to liquid carrying container 10. Usually, it will be desirable that that protective cylindrical over cap 102 opens and closes to the back or front of the liquid carrying container 10. In the illustrated embodiment, a hinged attachment 118, FIGS. 13 and 14, of the protective cylindrical over cap 102 is shown aligned with one of the downwardly extending tabs 116. With this arrangement of the hinge attachment 118 aligned with a tab 116, the orientation of the hinge attachment 118 with respect to the closure body 62 will be determined by the location of the cutouts 114 in bottom disk 106. If, as illustrated, the cutouts 114 are arranged parallel to the width of the liquid carrying compartment, the protective cylindrical over cap 102 will be rotated toward the back or the front of the liquid carrying compartment when opened, FIGS. 17B-17D, 19A, 20, 37A, 37B, and 38A. The hinge attachment 118 may be a thin flexible plastic attachment of the protective cylindrical over cap 102 to the over cap base 104 which may be formed by molding the protective cylindrical over cap 102, over cap base 104, and hinge attachment 118 as a single molded piece. The top of the protective cylindrical over cap 102 includes an opening tab 120 on the side of the protective cylindrical over cap 102 opposite the side having the hinge attachment. This tab 120 may be used by a user's thumb, FIG. 20, or by the user's teeth T, FIGS. 17B, 17C and 19A, to open protective cylindrical over cap 102. Once the protective cylindrical over cap 102 is opened, the user can use a thumb or fingers to open the push pull valve 80 or use the user's teeth to open the push pull valve 80, FIG. 19B. After drinking from the liquid container, if liquid is still left in the container, the push-pull element is closed and the protective cylindrical over cap may be closed by the user's hand or thumb or by rotating the protective cylindrical over cap 102 from open to closed position by pushing protective cylindrical over cap 102 against the user's teeth, the user, or any convenient surface. By using the protective cylindrical over cap 102 over the push-pull element 80, the push-pull element 80 can be kept clean and ready for use by the user without collecting dirt and other contaminants before use, during use, and between uses. Also, the protective cylindrical over cap 102 may be attached to the closure body so that in closed condition it is positioned very closely over or against the push-pull element in closed condition, FIG. 17A, to ensure that the push-pull element does not accidentally open when the protective cylindrical over cap 102 is in closed condition. In addition, with the protective cylindrical over cap 102 hinged to the liquid carrying container closure, the protective cylindrical over cap 102 remains with the liquid carrying container and is not separated and disposed of separately from the liquid carrying container itself.

The protective cylindrical over cap opening tab 120 provides a structural feature of the liquid carrying container to indicate to the user the front and the back of the liquid carrying container. Once the user knows the front and back of the liquid carrying container, the user can initially orient the liquid carrying container in the user's receiving uniform or gear pocket or ammunition magazine carrier in a desired predetermined front and back orientation. With this known front and back orientation, the user, without seeing the liquid carrying container or the user's receiving uniform or gear pocket or ammunition magazine, can reach and grab the liquid carrying container in one hand from the user's receiving uniform or gear pocket or ammunition magazine. The user then knows, again without seeing the liquid carrying container or the hand holding the liquid carrying container, the orientation of the liquid carrying container in the user's hand. The user can operate the liquid carrying container closure such as shown in FIGS. 19A and 19B or as shown in FIG. 20, and can drink from the liquid carrying container. When finished drinking, if liquid remains in the liquid carrying container, the user can then close the liquid carrying container closure by pushing the push-pull element to closed position and rotating the protective cylindrical over cap back over the push-pull element. The user can then replace the liquid carrying container back in the user's receiving uniform or gear pocket or ammunition magazine with the single hand holding the liquid carrying container and the liquid carrying container will have the same orientation and alignment as it had before being removed from the user's receiving uniform or gear pocket or ammunition magazine. This allows the one handed use of the liquid carrying container since the user does not have to think about and align the liquid carrying container and the liquid carrying container closure device from a different orientation each time it is to be used. If the liquid carrying container is empty after drinking by the user, the user can dispose of the liquid carrying container and obtain a new liquid carrying container to place in the user's uniform or gear pocket or ammunition magazine. The liquid carrying container as described is not designed to be refilled and reused.

For some specific situations, such as for personnel dealing with or in Chemical, Biological, Radiological, Nuclear, and Explosive Environments (CBRNE), such personnel wear protective face masks that do not have openings that allow the discharge spout of a water container to be placed in such person's mouth. Since hydration is often necessary for these people, many of the face masks used by such personnel, such as a Joint Services General Purpose Mask M-50/M-51 or M-53 A1 incorporate a tube extending therefrom having a face mask tube connector valve at the free end of the face mask tube which can be connected to a liquid source to supply liquid to the person wearing such face mask when liquid is desired by the person wearing the face mask. The face mask tube connector valve at the free end of the face mask tube extending from the face mask is usually designed to be connected to a rigid military canteen carried by the user or to a pack type water source which is carried as a pack by the user. The rigid military canteens are generally awkward to carry and hold by a user and have to be raised above the user's mouth level to allow the user to drink from the canteen. The pack type water sources are usually heavy and inconvenient for a user to carry. In many situation it would be convenient to have a smaller and lighter water source that can be easily carried by and manipulated by the user and be easily connected to the face mask tube connector valve at the end of the tube extending from the face mask when the user desires hydration. Further, a user in a contaminated CBRNE environment will not want to have to refill a canteens or pack type container when the container is empty. A convenient and easily carried liquid source and one that is disposable is provided by a liquid container of the invention. However, an adapter to be able to connect the face mask tube connector valve at the end of the face mask tube extending from the face mask to a push-pull element as used in the liquid container of the invention is necessary to use the container of the invention with the face mask.

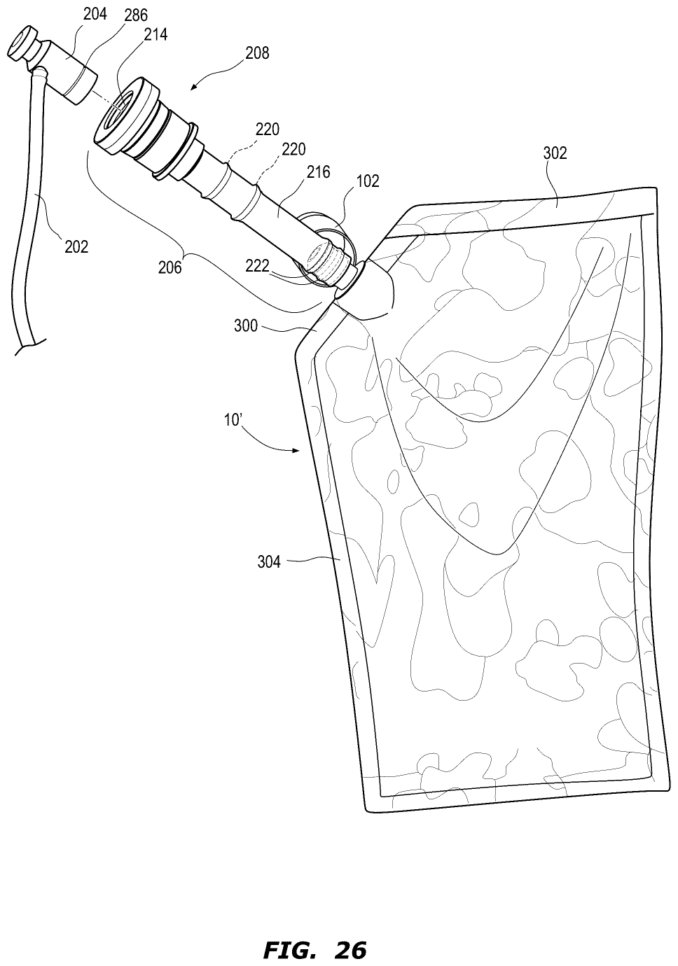

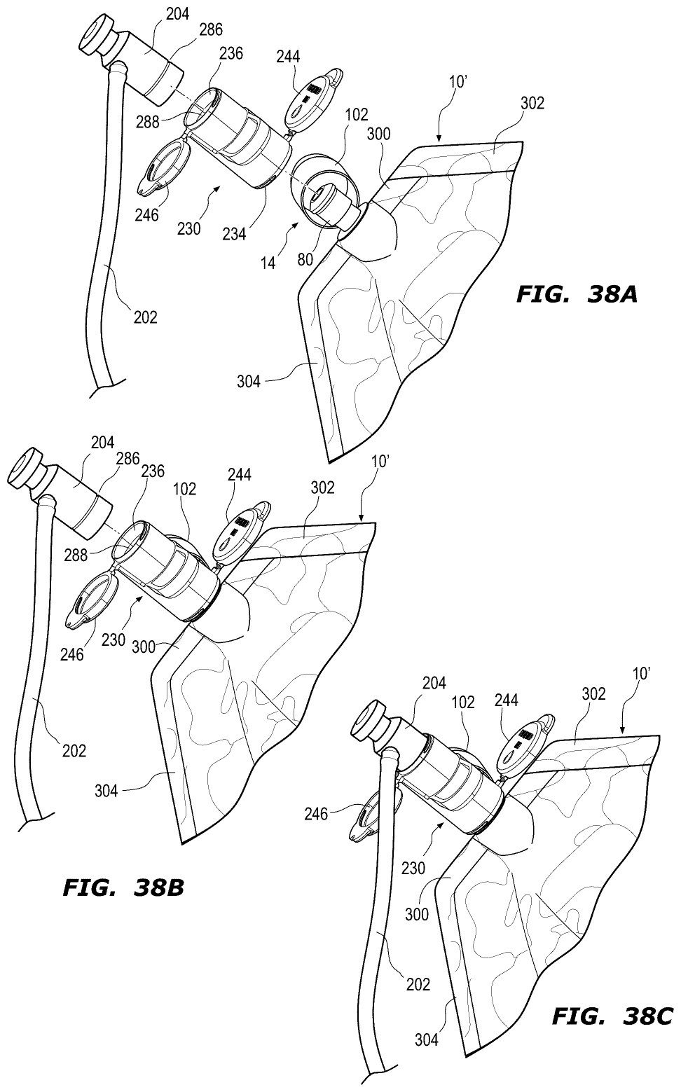

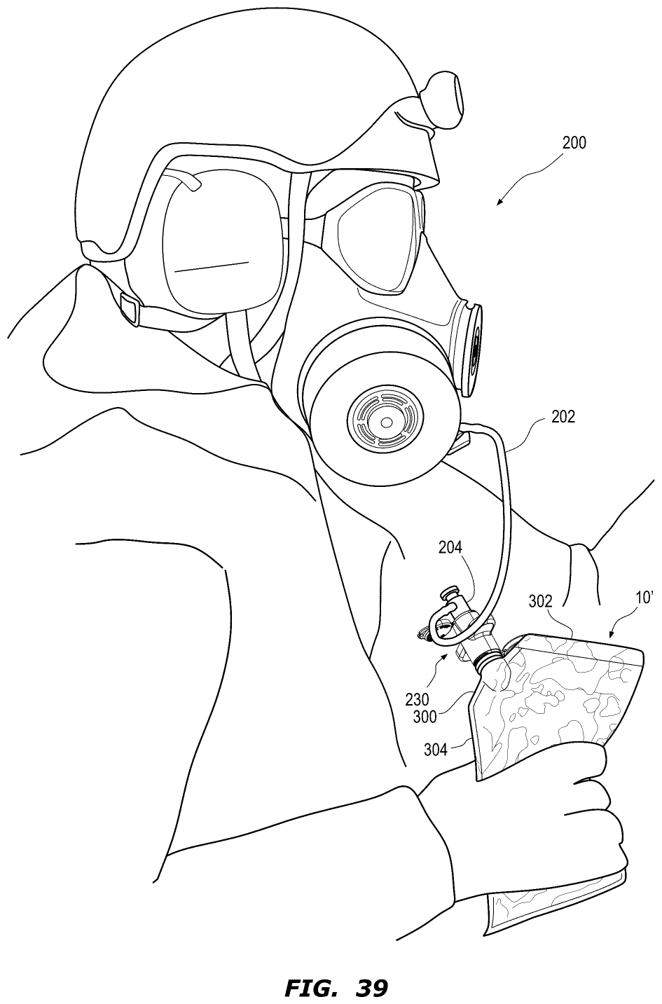

FIG. 39 shows a person wearing a face mask 200 having a face mask tube 202 extending from the front of the face mask and having a known face mask tube connector valve 204 connected to the free end of face mask tube 202. The face mask tube connector valve 204 is a military mask tube connector valve which is usually provided at the free end of face mask tube 202 for connecting the face mask tube 202 to a prior art top closure adapter of a military canteen, not shown, such as a military M1 NBC Canteen Drinking Cap, or to a closure adapter of a pack type liquid container, such as a Camelbak® pack type liquid container, not shown, such as a Camelbak® military hydration system gas mask adapter M50/40 quick connect valve. Instead, FIG. 39 shows the known face mask tube connector valve 204 connected to a liquid source connection adapter 230 of the invention which connects the face mask tube connector valve 204 to the push-pull element of a liquid carrying container 10′ of the invention. FIGS. 38A-38C show the connection of FIG. 39 in more detail. FIG. 38A is an exploded view of the connection shown in FIG. 39 of the liquid carrying container 10′ of the invention with the protective cylindrical over cap 102 rotated to open position to expose push-pull element 80 in closed position. The liquid source connection adapter 230 is positioned above push-pull element 80 and the face mask tube connector valve 204 is positioned above the liquid source connection adapter 230. FIG. 38B shows the liquid source connection adapter 230 pushed onto the push-pull element 80 with the face mask tube connector valve 204 still above liquid source connection adapter 230. FIG. 38C shows the face mask tube connector valve 204 pushed into the liquid source connection adapter 230. With this completed connection shown in FIG. 38C, the liquid source connection adapter 230 can be pulled upwardly in the direction away from liquid carrying container 10′ to pull push-pull element 80 into open position on liquid carrying container 10′. This is the connection as shown in FIG. 39 and allows liquid to flow from liquid container 10′ to face mask tube connector valve 204. FIG. 26, shows another embodiment of a liquid source connection adapter 206 connecting face mask tube connector valve 204 to the push-pull element of liquid carrying container 10′.

While the liquid carrying container to which either the liquid source connection adapter 230 is attached or liquid source connection adapter 206 is attached can be the liquid carrying container 10 as previously described, the liquid carrying container shown in FIGS. 26, 38A-38C, and 39 is a larger version of a liquid carrying container of the invention, indicated as 10′. While the liquid carrying container closure can extend from the top of the larger liquid carrying container 10′, the illustrated larger liquid carrying container 10′ does not have the liquid carrying container closure extending from the top edge of the liquid carrying compartment but includes an angled corner edge portion 300 extending between the top edge portion 302 and a side edge portion 304 at one side of the top of the liquid carrying compartment. This does not change the operation or function of the liquid carrying container or the liquid carrying container closure, but can change packing and storage considerations. The liquid carrying compartment closure does not extend the height of the liquid carrying container 10′. The liquid carrying compartment closure 14 is still secured in the liquid carrying container in the same way with a canoe portion of the closure secured between the edges of the front panel and the back panel, but in the angled corner portion 300 rather than in the top portion. The liquid carrying compartment closure 14 operates the same way and is aligned the same way. Although this larger container 10′ is shown in FIGS. 26, 38A-38C, and 39 with a substantially straight bottom edge as previously described, this larger container does not necessarily have a same straight bottom edge as the smaller container previously described and may have a bottom gusset forming a broader flat bottom that may not easily fit into a pocket using one hand holding the container. The larger container of the invention may be about twice the size of the smaller container and hold about 500 milliliters (almost 17 ounces) of liquid, but still has the same container closure 14 as previously described, which includes protective over cap assembly 100 which can be moved between closed and open positions and the push-pull element 80 which forms the drinking spout for the liquid carrying container.

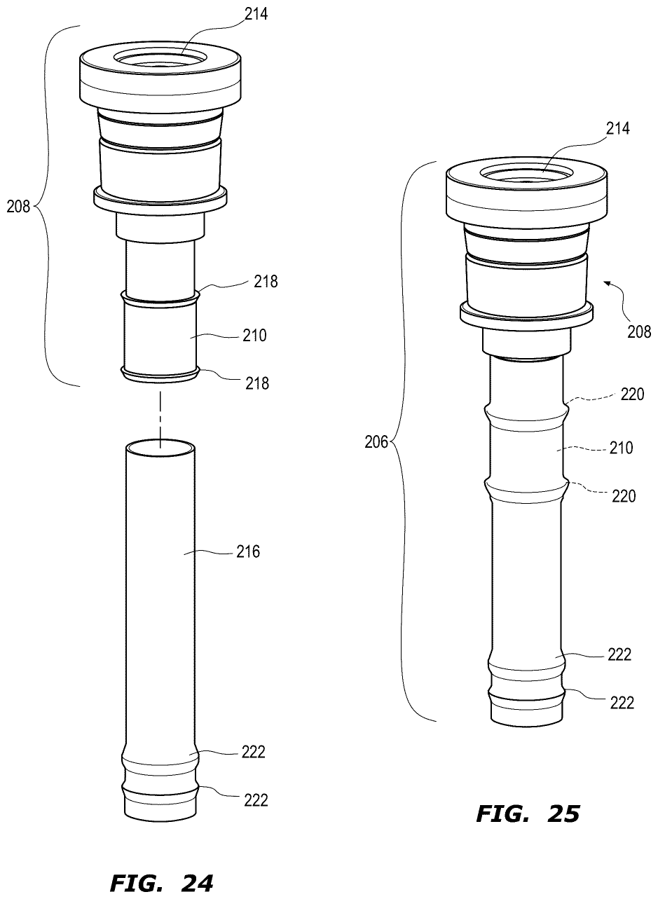

A first embodiment of a liquid source connection adapter of the invention is shown in FIGS. 24-26 and is indicated in FIGS. 25 and 26 by reference number 206. In this first embodiment of a liquid source connection adapter of the invention, a prior art closure adapter of a pack type liquid container, such as a Camelbak® military hydration system gas mask adapter M50/40 quick connect valve, type-A, is used as part of the liquid source connection adapter of the invention. In FIGS. 24-26, the Camelbak® military hydration system gas mask adapter M50/40 quick connect valve, type-A, is shown as forming the top part of the liquid source connection adapter 206 and is identified by reference number 208. A substantially rigid tube 210 forms the lower part of the Camelbak® connector 208. The top part of the Camelbak® connector 208 includes a receiving opening 214 to receive the lower connecting portion of the face mask tube connector valve 204. The usual face mask tube connector valve 204 is a normally closed valve which opens when connected to a water source having a prior art top closure adapter such as a top closure adapter of a military canteen or of a pack type liquid container. The top part of the Camelbak® connector 208 as used in the adapter 206 of the invention also includes a normally closed valve therein, not shown, which opens when the lower connecting portion of the face mask tube connector valve 204 is inserted into receiving opening 214 and which also acts to open normally closed face mask tube connector valve 204, thereby connecting face mask tube 202 from the face mask into rigid tube 210. Rigid tube 210 in the prior art Camelbak® military hydration system face mask adapter would be connected to the Camelbak® pack type liquid container to allow liquid to flow from the Camelbak® pack type liquid container into face mask tube 202 and to the face mask 200. However, for the liquid source connection adapter of the invention, a somewhat flexible tube 216 is slid over the end of the substantially rigid tube 210 and forms the lower part of the liquid source connection adapter 206.

Substantially rigid tube 210 includes two ridges 218 over which somewhat flexible tube 216 is pushed during assembly of the liquid source connection adapter of the invention to form a liquid tight connection. These ridges 218 will displace the sides of the somewhat flexible tube 216 outwardly as shown at 220 in FIGS. 25 and 26 which hold somewhat flexible tube 218 securely on substantially rigid tube 210. The opposite end portion of somewhat flexible tube 216 includes interior circumferential grooves which show as exterior ridges 222 in FIGS. 24-26. These circumferential grooves 222 will accept ridges formed on the push-pull element of the liquid container of the invention. With the push-pull element 80 of the invention as illustrated in FIGS. 10, 17B, 17C, and 17D wherein the push-pull element 80 has a single top flange 96, when the protective cylindrical over cap top 102 of compartment closure 14 is opened to expose the push-pull element 80, as shown in FIGS. 17B, 17C, 17D, and 26, the lower end of somewhat flexible tube 216 can be pushed over the top flange 96 of push-pull element 80 so that the top flange 96 is pushed into somewhat flexible tube 210 until it is received by a circumferential indentation 222, preferably the upper circumferential indentation 222. When received in one of the circumferential indentations 222, the indentation holds the top flange 96 of the push-pull element 80. When the somewhat flexible tube 218 is connected to the push pull-valve element 80, the face mask tube connector valve 204 can be connected in receiving opening 214 of the Camelbak® connector 208 which forms the upper end of liquid source connection adapter 206. This will open the valves in both the face mask tube connector valve 204 and in Camelbak® connector 208 and connect the face mask tube 202 from the face mask to the somewhat flexible tube 216. The user can then pull the somewhat flexible tube 218 to open the push-pull element 80 of the liquid container of the invention and connect the liquid carrying container to the face mask tube 202 extending from the face mask. The user can then drink liquid from the liquid carrying container 10′. The liquid can be sucked by the user from the liquid carrying container 10′ which collapses the liquid container 10′ or the liquid container 10′ can be squeezed by the user to force liquid from liquid carrying container 10′ through face mask tube 202 to the user. The user could also hold the liquid carrying container above the user's mouth so that liquid can flow by gravity out of the liquid carrying container to the user.

In use, the liquid source connection adapter 206 will generally be pushed over the push-pull element 80 to attach it to the push-pull element and such pushing will ensure that the push-pull element is in the closed condition. When connected to the push-pull element of the liquid carrying container, when the user wants a drink, the face mask tube connector valve 204 at the end of face mask tube 202 will be connected to liquid source connection adapter 206 by pushing the face mask tube connector valve 204 into receiving opening 214 of the Camelbak® connector 208 which forms the top end of liquid source connection adapter 206. The liquid source connection adapter 206 is pulled to pull the push-pull element 80 to open position and the user can drink. When finished drinking, liquid source connection adapter 206 can be pushed toward the liquid carrying container to move the push-pull element to closed position and the face mask tube connector valve 204 can be pulled from Camelbak® connector 208 at the top of liquid source connection adapter 206. When separated, the valves in the Camelbak® connector 208 and the face mask tube connector 204 will automatically close to keep out contaminants. The liquid source connection adapter 206 can remain connected to the push-pull element or can be removed from the push-pull element. The liquid carrying container with the liquid source connection adapter of the invention 206 remaining attached to the push-pull element of the liquid carrying container can be placed in a convenient spot, such as user uniform or special gear pockets or other holder for storage for future use. Alternately, the liquid source connection adapter 206 can be removed from the push-pull element 80 of the liquid carrying container and carried separately in a user uniform or special gear pocket or carrier to be replaced on the push-pull element 80 when further drinking is desired. If the liquid source connection adapter 206 is removed from the push-pull element, the user will need to ensure to push the push-pull element back to closed position after removal of the liquid source connection adapter 206. When not connected to the push-pull element 80, the unconnected end of the somewhat flexible tube 216 can have a stopper put therein or cover placed thereover, not shown, to prevent the entry of contaminants to the inside of somewhat flexible tube 216. Such stopper or cover will be removed from the end of somewhat flexible tube 216 immediately before connection or reconnection to the push-pull element 80. If the liquid carrying container is emptied, it, along with the used liquid source connection adapter 206, can be disposed of. A new full liquid carrying container and a new liquid source connection adapter 206 will be obtained by the user.

To increase the integrity of the connection of somewhat flexible tube 206 to the push-pull element 80 of the liquid carrying container, the push-pull element 80 can be formed with an intermediate flange 224, FIGS. 22 and 23. With the intermediate flange 224 of the push pull valve 80, when somewhat flexible tube 210 is pushed onto the push-pull element 80, it is pushed onto push-pull element 80 far enough so that the push-pull element flange 96 will snap into the upper circumferential indentation 222 and the intermediate flange 224 will snap into the lower circumferential indentation 222, FIG. 26. This will provide about double the holding strength for the somewhat flexible tube 210 to the push-pull element 80 to help ensure that the liquid source connection adapter 206 is not accidently disconnected from the push-pull element during use.

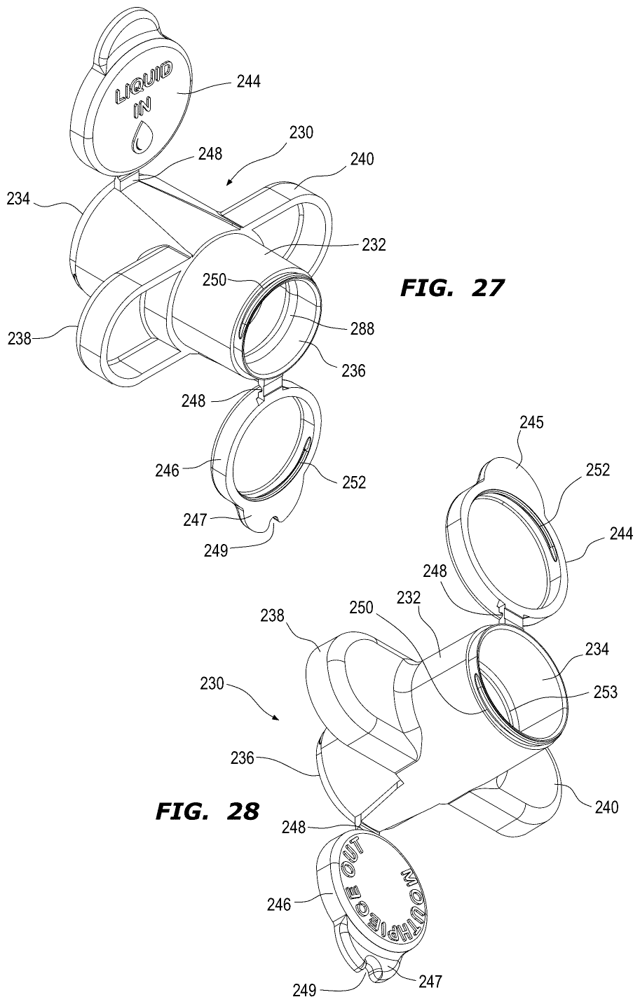

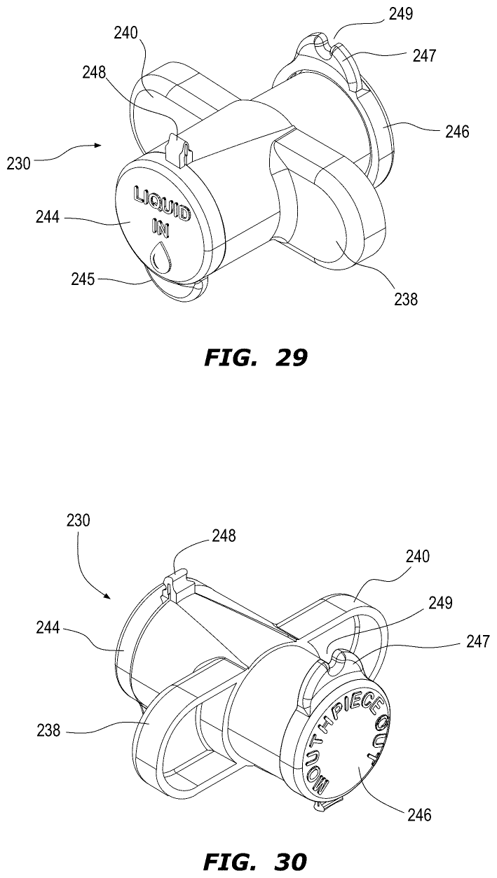

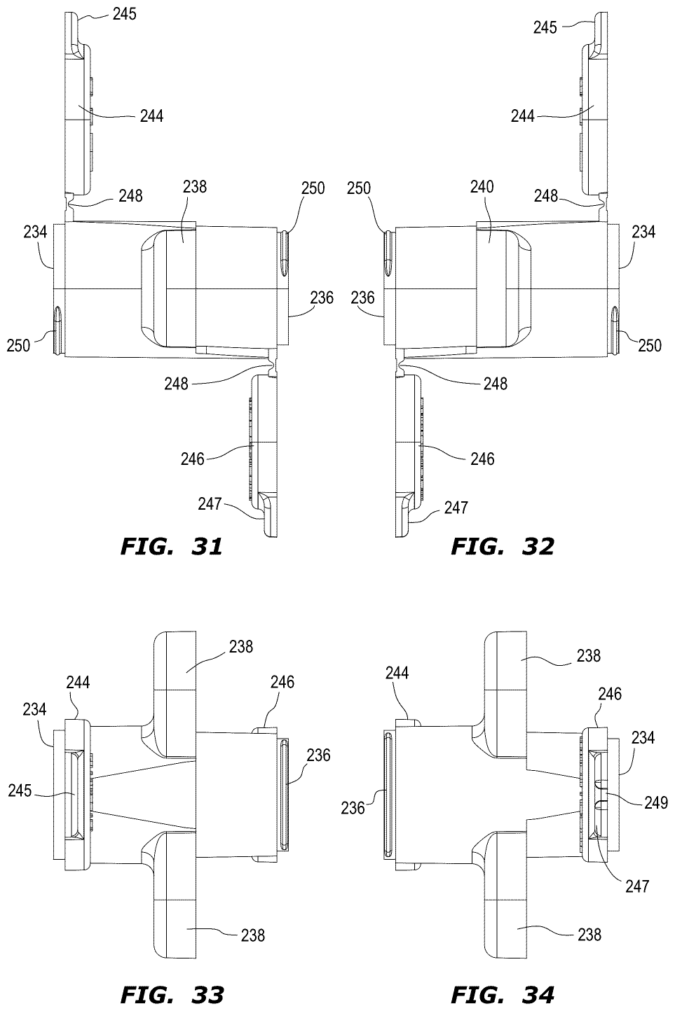

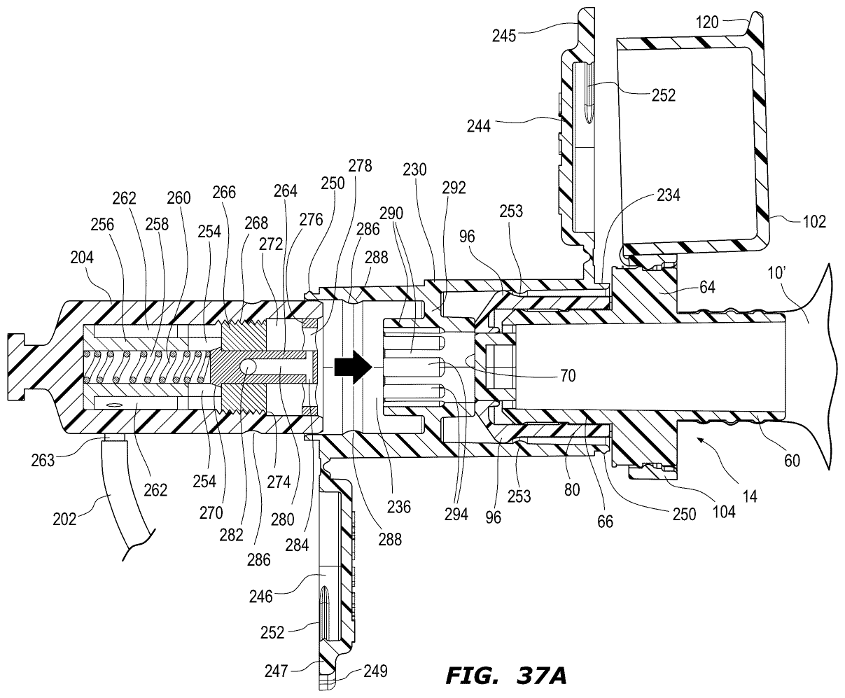

A second embodiment 230 of a liquid source connection adapter is shown in FIGS. 27-39. This second embodiment of liquid source connection adapter 230 includes a substantially tubular adapter body 232 having opposite open adapter ends 234 and 236 and adapter handle portions 238 and 240 extending from opposite sides of adapter body 232. Adapter end caps 244 and 246 are hingedly attached to the ends 234 and 236 of adapter body 232. Adapter open end 234 is the liquid inlet of adapter 230 and adapter end cap 244 which covers adapter open end 234 is labeled “liquid in”. Adapter open end 236 is the liquid outlet of adapter body 230 and adapter end cap 246 which covers adapter open end 236 is labeled “mouthpiece out”. The entire liquid source connection adapter 230 can be molded as a single piece from a plastic material with thin connections 248, FIGS. 27-32, hingedly attaching the adapter end caps 244 and 246 to the adapter body 232. With these hinge connections, adapter end cap 244 can be rotated between closed condition over adapter liquid inlet open end 234 of adapter body 232, FIGS. 29 and 30, and open condition shown in FIGS. 27, 28, 31, and 32. Similarly, adapter end cap 246 can be rotated between closed condition over adapter liquid outlet open end 236 of adapter body 232, FIGS. 29 and 30, and open condition shown in FIGS. 27, 28, 31, and 32. Adapter end cap 244 which covers adapter input 234 can include a tab 245 to help open end cap 244. Adapter end cap 246 which covers adapter outlet 236 can include a tab 247 to help open end cap 246. A groove 249 can be provided in outlet cap tab 247 to identify the adapter outlet which outlet cap 246 covers. Adapter ends 234 and 236 each include a ridge 250 extending outwardly partially around the outer edge of ends 234 and 236 and the end caps 244 and 246 include flanges 252 extending inwardly partially around the inside of the cap rims which flex over ridges 250 when the caps are rotated to closed position to hold caps 244 and 246 in closed condition. In closed condition, the adapter caps substantially seal the respective adapter ends of the adapter body 232 to keep contaminants out of the adapter body. The molded adapter body 232 is small having a length of about two inches.

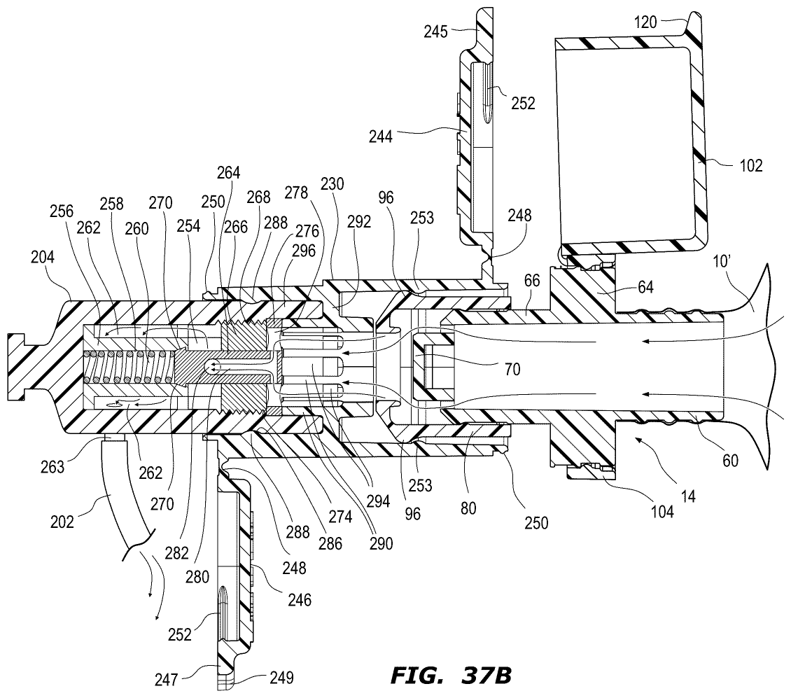

This second embodiment 230 of liquid source connection adapter provides a single piece adapter 230 which fits between the prior art face mask tube connector valve 204 and the push-pull element 80 of the liquid carrying closure 14 of the liquid carrying container. To connect liquid source connection adapter 230 to the push-pull element 80 of the liquid carrying container 10′, the protective cylindrical over cap 102 of the liquid carrying container closure 14 of liquid carrying container 10′ is rotated to open position to expose the push-pull element 80. Cap 244 over the open inlet end 234 of liquid source connection adapter 230 is opened, and the open inlet end 234 of the liquid source connection adapter 230 is forced over the push-pull element 80, FIGS. 37A-B and 87A-B. The diameter of the opening of inlet end 234 is sized to fit snugly over push-pull element flange 96. In addition, an inwardly extending flange 253 inside the body of the liquid source connection adapter 230 toward the inlet end 234, FIGS. 28, 37A, and 37B, is also pushed over push-pull element flange 96. Liquid source connection adapter handles 238 and 240 can be used, if necessary, to push the liquid source connection adapter 230 onto push-pull element 80. The inwardly extending flange 253, once pushed over push-pull element flange 96, holds the liquid source connection adapter 230 on push-pull element 80 and resists removal of the liquid source connection adapter 230 from push-pull element 80 during normal use. The snug fit of the liquid source connection adapter 230 over push-pull element flange 96, and the inwardly extending flange 253 both resist leakage of liquid around the outside of push-pull element 80. Liquid source connection adapter 230 is now connected to the push-pull element 80 of the liquid carrying container. FIG. 37A shows push-pull element 80 in its closed position and FIG. 37B shows push-pull element 80 in its open position. Liquid source connection adapter 230 as connected to push-pull element 80 can be moved in a direction toward the liquid carrying container 10 to put the push-pull element 80 in closed condition or moved in a direction away from liquid carrying container 10 to put push-pull element 80 in an open condition. Handles 238 and 240 can be used if necessary to move liquid source connection adapter 230 with respect to liquid carrying container 10. In this particular instance, push-pull element 80 should be put in and remain in closed condition to prevent liquid flow into and out of the liquid source connection adapter 230.

To connect liquid source connection adapter 230 to the prior art face mask tube connector valve 204, cap 246 over the outlet end 236 of liquid source adapter 230 is opened and the face mask tube connector valve 204 is pushed into open outlet end 234 of the liquid source connection adapter 230. However, as indicated, the prior art face mask tube connector valve 204 includes a normally closed valve to keep contaminants out of the face mask tube. This normally closed valve needs to be opened when the face mask tube connector valve 204 is connected to a liquid source. Thus, the outlet end of the liquid source connection adapter 230 that attaches to the face mask tube connector valve 204 has to be configured to open the normally closed valve in the face mask tube connector valve 204 when the face mask tube connector valve 204 is connected to the outlet end 236 of the adapter body. FIGS. 37A and 37B show longitudinal cross sections of the liquid source connection adapter 230 attached to the push-pull element 80 of the closure 14 of a liquid carrying container and shows the face mask tube connector valve 204 ready to connect to the outlet end 236 of the liquid source connection adapter 230, FIG. 37A, and connected to the outlet end 236 of the liquid source connection adapter 230, FIG. 37B. As seen in FIG. 37A, the face mask tube connector valve 204 which is not yet connected to liquid source connection adapter 230 includes a first cylindrical chamber 254 containing a sleeve 256 therein dividing the first cylindrical chamber into valve spring holding chamber 258 with valve spring 260 therein and an open chamber 262 around the sleeve 256. A connector 263 connects the open chamber 262 to the face mask tube 202.

The end of a valve stem 264 extends snugly through an opening centered in a threaded plug 266 which is screwed into a threaded portion 268 at the open end of first cylindrical chamber 254. The end of valve stem 264 extending through the opening centered in threaded plug 266 abuts the end of valve spring 260 and has an outwardly projecting flange 270 larger than the centered opening so that the end of valve stem 264 cannot pass through the centered opening in threaded plug 266. Valve spring 260 biases the valve stem outwardly projecting flange 270 against threaded plug 266. Valve stem 264 extends from the outwardly projecting flange 270 through threaded plug 266 and into a second cylindrical chamber 272 slightly larger in diameter than the first cylindrical chamber 254 creating a step 274 at the junction of the first cylindrical chamber and the second larger diameter cylindrical chamber. The outer end of the threaded plug 266 is aligned with this step 274. Valve stem 264 extends into the second cylindrical chamber 272 and connects with a valve head 276 in the form of a disc of diameter just slightly less than the diameter of the second cylindrical chamber 272 so is slidable in the second cylindrical chamber. Valve stem 264 is of a length so that the end of valve head 276 away from connection to valve stem 264 is about even with the bottom of the face mask tube connector valve 204 when the normally closed valve is closed as shown in FIG. 37A. Valve head 276 includes openings 278 therethrough leading into the second cylindrical chamber 272. Valve stem 264 includes a central passage 280 extending from its connection to valve head 276 to an opening 282 intermediate the length of valve stem 264 and has openings 284 from the second cylindrical chamber 272 into central passage 280 adjacent the connection of the valve head 276 to the valve stem 264. With this construction of face mask tube connector valve 204 as shown in FIG. 37A, before connection to liquid source connection adapter 230, face mask tube connector valve 204 is in its normally closed condition. In this closed condition, the opening 282 intermediate the length of valve stem 264 is located inside the threaded plug 266 which blocks opening 282 so fluid cannot flow from valve stem central passage 280 out of opening 282.

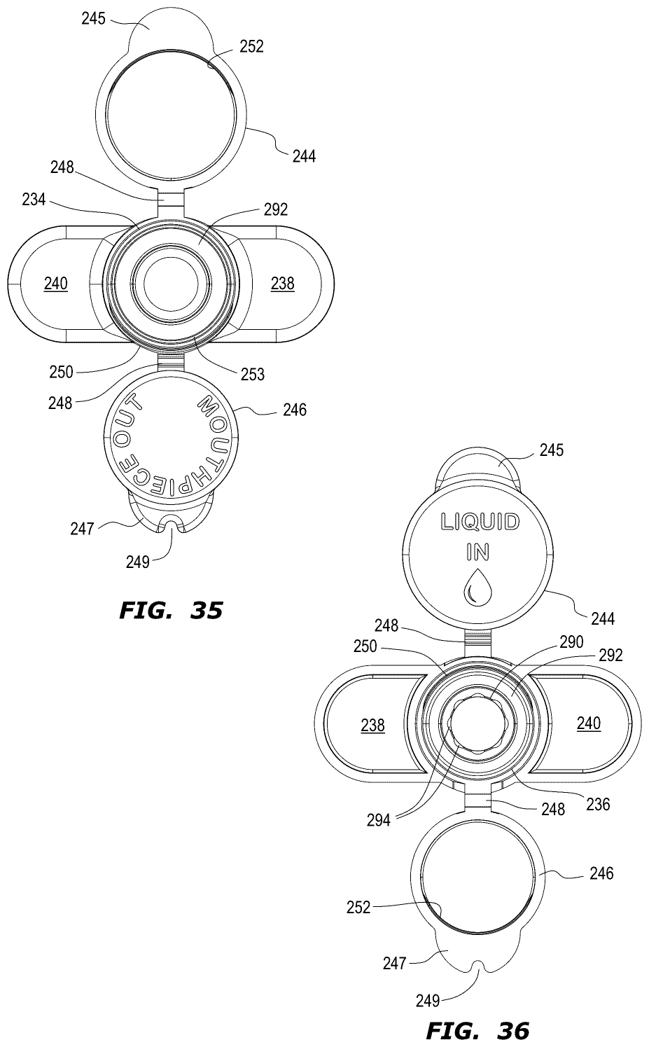

To connect face mask tube connector valve 204 to liquid source connection adapter 230, face mask tube connector valve 204 is pushed into the liquid outlet end 236 of liquid source connection adapter body 230. Face mask tube connector valve 204 has a circumferential groove 286 in its outside body near its end which will be pushed into the liquid outlet end 236 of liquid source connection adapter body 230, FIGS. 37A and 38 A-B. An inner circumferential flange 288 is molded into liquid source connection adapter body 230 near its outlet end 236, FIGS. 27, 37A, and 37B. When pushed into liquid outlet end 236 of liquid source connection adapter body 230, circumferential groove 286 of face mask tube connector valve 204 mates with inner circumferential flange 288 of liquid source connection adapter 230, FIG. 37B. This mating of groove 286 with flange 288 locates face mask tube connector valve 204 in liquid outlet end 236 of liquid source connection adapter body 230 and holds it in position during use. Liquid source connection adapter body 230 includes a valve actuator molded into the liquid source connection adapter body 230. The valve actuator comprises a molded tube 290, held in place in the liquid source connection adapter body 230 by a molded connector 292 extending between the outer wall of tube 290 intermediate the length of the tube 290 and the inner wall of connection adapter body 230, FIGS. 35, 36, 37A, and 37B. Molded tube 290 has an outside diameter just slightly less than the diameter of the face mask tube connector valve second cylindrical chamber 272 so the tube 290 will slid into the face mask tube connector valve second cylindrical chamber 272. The end of molded actuator tube 290 toward the outlet end of the adapter body 232 has a series of grooves 294 along the inside of the tube wall. When the face mask tube connector valve 204 is pushed into the open outlet end 236 of the liquid source connection adapter 230, the grooved end of tube 290 toward the outlet end of the adapter body 232 engages the outer circumferential edge portion of valve head 276 and pushes valve head 276 and valve stem 274 against valve spring 260 to slide valve head 276 in the second cylindrical chamber 272 through the second cylindrical chamber 272 to abut step 274 and the outer circumferential edge portion of threaded plug 266 as shown in FIG. 37B. In this position the grooved outlet end of tube 290 of adapter body 232 is in the second cylindrical chamber of the face mask tube connector valve 204. Additionally, in this position the opening 282 intermediate the length of valve stem 264 opens into first cylindrical chamber open chamber 254. This places the normally closed valve of the face mask tube connector valve 204 in open position. The liquid source connection adapter 230, which has already been connected to the push-pull element 80 of the liquid carrying container closure 14, can be pulled to move the push-pull element 80 to open position. Liquid can then flow from the liquid carrying container through the push-pull element 80 into the liquid inlet end 232 of the liquid source connection adapter 230. The liquid will then flow into the tube 290 in the liquid source connection adapter 230 and through the tube grooves 294 and the end of tube 290 into the first cylindrical chamber of the face mask connector tube valve 204 which has been pushed into the outlet end of the liquid source connection adapter 230. With the face mask connector tube valve 204 in open condition as shown in FIG. 37B, the liquid that flows from the liquid outlet of the liquid source connection adapter 230 into the second cylindrical chamber of the face mask connector tube valve 204 can flow through valve head openings 278, openings 284, central stem passage 280, out opening 282 into first cylindrical chamber 254 and open chamber 262 and out of open chamber 262 through connector 263 into face mask tube 202. This allows liquid from the liquid carrying container to flow into face mask tube 202 and to the user wearing the face mask. When the user has had enough to drink, liquid source connection adapter 230 can be pushed toward the liquid carrying container to move push-pull element 80 to closed condition and face mask connector tube valve 204 can be pulled from the outlet end of the liquid source connection adapter 230. It should be noted that as shown in FIGS. 37A-B, the inlet end of tube 290 in liquid source connection adapter 230 toward the inlet end of liquid source connection adapter 230, abuts the end of push-pull element 80 so that pushing the liquid source connection adapter 230 toward the pus-pull element 80 will push the push-pull element 80 to closed position. If liquid remains in the liquid carrying container, the liquid carrying container can be saved for later use, or, if the liquid carrying container is empty, it can be disposed of and a new liquid carrying container can be used when additional liquid is desired.

As previously indicated, FIG. 39 shows a user wearing a face mask 200 having a face mask tube 202 extending from the front of the face mask and having a known face mask tube connector valve 204 connected to the free end of face mask tube 202. FIG. 39 shows the face mask tube connector valve 204 connected to the second embodiment liquid source connection adapter 230 of the invention which connects the face mask tube connector valve 204 to a push-pull element of the larger liquid carrying container 10′ of the invention. However, the liquid source connection adapters of the invention can be used with the smaller liquid carrying container, or with other and larger liquid carrying containers which have container closures with push-pull elements.

Whereas the invention is here illustrated and described with reference to specific embodiments thereof presently contemplated as the best mode of carrying out the invention in actual practice, it is to be understood that various changes may be made in adapting the invention to different embodiments without departing from the broader inventive concepts disclosed herein and comprehended by the claims that follow. Further, where direction such as up and down, top and bottom, etc., have been used in describing the embodiments shown in the drawings, such directions merely describe the invention and operation of the invention with respect to the orientations shown in the particular drawings and are not limiting as to other orientations and directions.

1. A liquid carrying container including a sealed liquid carrying compartment with edge portions and a container closure device operable to sealingly close the compartment or to open the compartment to allow liquid to flow from the compartment through a discharge spout, said container closure device comprising:
a closure body having an attachment portion sealed into an edge portion of the liquid carrying compartment, a spacer extending from the attachment portion away from the compartment, a stem portion extending from the spacer portion and having an end opposite from the spacer portion with an opening therein, and a passage extending through the attachment portion, the spacer, and the stem portion, to the opening in the end of the stem portion through which a liquid can flow from the liquid containing compartment through the stem portion and stem opening;
a push-pull element slidably received on the stem portion that in one position with respect to the stem portion closes the opening in the stem portion and in a second position with respect to the stem portion opens the opening in the stem portion to form a discharge spout; and
an over cap assembly removably positioning a protective over cap over the stem portion and push-pull element to be movable between a protective position to block access to the stem portion and push-pull element and to an open position to allow access to the stem portion and push-pull element;
said securing portion being aligned with said liquid carrying compartment in a predetermined and known orientation and said over cap assembly being aligned with said closure body in a predetermined and fixed orientation.

2. A liquid carrying container according to claim 1, wherein said liquid carrying compartment has a width, wherein the attachment portion is an elongate canoe portion which is aligned with the carrying compartment width, and wherein the predetermined and fixed orientation of said over cap assembly is such that the over cap opens in a direction transverse to the width of the liquid carrying compartment to allow easy opening of the over cap.

3. A liquid carrying container according to claim 2, wherein the over cap assembly includes an over cap hinged to an over cap assembly base attached to the spacer.

4. A liquid carrying container according to claim 3, wherein the over cap assembly base extends around the spacer with a friction fit and includes alignment means to align the opening movement of the over cap with respect to the canoe.

5. A liquid carrying container according to claim 4, wherein the alignment means includes a tab extending from the over cap assembly base into a receiving recess in the spacer.

6. A liquid carrying container according to claim 5, wherein the over cap includes a tab extending from the over cap which can be used to open the over cap.

7. A liquid carrying container according to claim 6, wherein the push-pull element includes a bevel which can be used to pull the push-pull element along the stem to open the opening in the stem.

8. A liquid carrying container according to claim 1 wherein the liquid carrying compartment has a top edge portion and a bottom edge portion opposite the top edge portion.

9. A liquid carrying container according to claim 8, wherein the liquid carrying compartment includes a front, a back, and opposite sides.

10. A liquid carrying container according to claim 9, wherein the sides include gussets.

11. A liquid carrying container according to claim 10, wherein the container is formed of a soft flexible nonreflecting material and is substantially shape retaining.

12. A liquid carrying container according to claim 11, wherein the container is formed of a sandwich material including an inner layer of a food grade material, an intermediate layer of material to provide strength and an oxygen barrier, and an outer layer of a soft mat finish material.

13. A liquid carrying container according to claim 12, wherein the food grade material is a food grade polyethylene material, the middle layer is a nylon material, and the soft mat finish outer layer is a PET material that can be reverse printed with a design.

14. A liquid carrying container according to claim 13, wherein the attachment portion sealed into an edge portion of the liquid carrying compartment is sealed into the top edge portion of the liquid carrying compartment so that the container closure device extends from the top edge of the liquid carrying compartment.

15. A liquid carrying container according to claim 14, wherein the container is sized to fit into a military soldier's pockets, pouches, or ammunition magazine carriers.

16. A liquid carrying container according to claim 8, wherein the liquid carrying compartment includes a side edge portion and an angled edge portion extending between the top edge portion and the side edge portion, and wherein the attachment portion is sealed into the angled edge portion of the liquid carrying compartment so that the container closure device extends from the angled edge of the liquid carrying compartment.

17. A liquid carrying container according to claim 1, wherein the liquid carrying compartment comprises:
a compartment front panel having a front panel top edge portion, a front panel bottom edge portion, and opposite front panel side edge portions;
a compartment back panel having a back panel top edge portion, a back panel bottom edge portion, and opposite back panel side edge portions;
a pair of side gussets extending between the respective side edge portions of the front panel and the respective side edge portions of the back panel;
and wherein at least a portion of the front panel bottom edge portion and a corresponding portion of the back panel bottom edge portion are sealingly secured together to form a liquid carrying compartment bottom edge portion.

18. A liquid carrying container according to claim 17, wherein the closure body attachment portion is an elongate canoe portion sealingly secured between a portion of the front panel top edge portion and a corresponding portion of the back panel top edge portion.

19. A liquid carrying container according to claim 18, wherein portions of the front panel top edge portion and corresponding portions the back panel top edge portion adjacent the liquid carrying container closure canoe portion are sealingly secured together.

20. A liquid carrying container according to claim 19, wherein the side gussets are each substantially rectangular with each of the side gussets having opposite gusset side edge portions, a gusset top edge portion, and a gusset bottom edge portion, wherein each of the side gussets are folded in half to form a gusset fold line parallel to the gusset side edges and dividing the gusset top edge portion into a first half gusset top edge portion and a second half gusset top edge portion and dividing the gusset bottom edge portion into a first half gusset bottom edge portion and a second half gusset bottom edge portion, wherein for each side of the liquid carrying compartment one gusset side edge portion is sealingly attached to the front panel side edge portion, the opposite gusset side edge portion is sealingly attached to the back panel side edge portion, the first half gusset top edge portion is sealingly attached to the front panel top edge portion and the second half gusset top edge portion is sealingly attached to the back panel top edge portion and the first half gusset bottom edge portion is sealingly attached to the front panel bottom edge portion and the second half gusset bottom edge portion is sealingly attached to the back panel bottom edge portion, and wherein the portions of the front panel top edge portion and corresponding portions the back panel top edge portion adjacent the liquid carrying container closure canoe portion that are sealingly secured together extend between the liquid carrying container closure canoe portion and the respective side gusset fold lines to form a completely sealed liquid carrying container top edge.

21. A liquid carrying container according to claim 20, wherein the portion of the front panel bottom edge portion and corresponding portion of the back panel bottom edge portion that are sealingly secured together extends between the respective side gusset fold lines to form a completely sealed and substantially straight liquid carrying container bottom edge.

22. A liquid carrying container according to claim 1, additionally including an adapter for connecting a face mask tube extending from a face mask and having a face mask tube connector valve secured to the end of the face mask tube, wherein the adapter comprises:
an elongate adapter body forming a face mask tube connector valve receiver at one end of the adapter body for receiving and opening the face mask tube connector valve; and
a push-pull element receiver formed at the other end of the body for receiving and operating the push-pull element of the liquid carrying container whereby liquid from the liquid carrying container can be dispensed from the liquid carrying container through the push-pull element, the adapter, and the face mask tube connector valve to the face mask tube.

23. A liquid carrying container according to claim 22, wherein the push-pull element of the liquid carrying container has a flange extending from the push-pull element, and wherein the push-pull element receiver of the adapter fits tightly over the push-pull element flange so movement of the adapter with respect to the liquid carrying container causes operable movement of the push-pull element.

24. A liquid carrying container according to claim 23, wherein the face mask tube connector valve is a normally closed valve and the adapter face mask tube connector valve receiver includes a cylindrical tube therein which interfaces with the face mask tube connector valve to open the face mask tube connector valve when the face mask tube connector valve is inserted into the adapter face mask tube connector valve receiver.

25. A liquid carrying container according to claim 24, wherein the end portion of the adapter cylindrical tube which interfaces with the face mask tube connector valve to open the face mask tube connector valve includes an end portion having a plurality of grooves therein through which liquid can pass when the face mask tube connector valve is inserted into the face mask tube connector valve receiver.

26. A liquid carrying container comprising a liquid carrying compartment and a liquid carrying container closure operable to sealingly close the liquid carrying compartment or to open the liquid carrying compartment to allow liquid to flow from the liquid carrying compartment through a container closure discharge spout, said liquid carrying compartment comprising:
a compartment front panel having a front panel top edge portion, a front panel bottom edge portion, and opposite front panel side edge portions;
a compartment back panel having a back panel top edge portion, a back panel bottom edge portion, and opposite back panel side edge portions;
a pair of side gussets extending between the respective side edge portions of the front panel and the respective side edge portions of the back panel;
and wherein at least a portion of the front panel bottom edge portion and a corresponding portion of the back panel bottom edge portion are sealingly secured together to form a liquid carrying compartment bottom edge portion.

27. A liquid carrying container according to claim 26, wherein the liquid carrying container closure includes an elongate canoe portion to connect the liquid carrying container closure to the liquid carrying compartment and wherein the liquid carrying container closure elongate canoe portion is sealingly secured between a portion of the front panel top edge portion and a corresponding portion of the back panel top edge portion.

28. A liquid carrying container according to claim 27, wherein portions of the front panel top edge portion and corresponding portions the back panel top edge portion adjacent the liquid carrying container closure canoe portion are sealingly secured together.

29. A liquid carrying container according to claim 28, wherein the side gussets are each substantially rectangular with each of the side gussets having opposite gusset side edge portions, a gusset top edge portion, and a gusset bottom edge portion, wherein each of the side gussets are folded in half to form a gusset fold line parallel to the gusset side edges and dividing the gusset top edge portion into a first half gusset top edge portion and a second half gusset top edge portion and dividing the gusset bottom edge portion into a first half gusset bottom edge portion and a second half gusset bottom edge portion, wherein for each side of the liquid carrying compartment one gusset side edge portion is sealingly attached to the front panel side edge portion, the opposite gusset side edge portion is sealingly attached to the back panel side edge portion, the first half gusset top edge portion is sealingly attached to the front panel top edge portion and the second half gusset top edge portion is sealingly attached to the back panel top edge portion and the first half gusset bottom edge portion is sealingly attached to the front panel bottom edge portion and the second half gusset bottom edge portion is sealingly attached to the back panel bottom edge portion, and wherein the portions of the front panel top edge portion and corresponding portions the back panel top edge portion adjacent the liquid carrying container closure canoe portion that are sealingly secured together extend between the liquid carrying container closure canoe portion and the respective side gusset fold lines to form a completely sealed liquid carrying container top edge.

30. A liquid carrying container according to claim 29, wherein the portion of the front panel bottom edge portion and corresponding portion of the back panel bottom edge portion that are sealingly secured together extends between the respective side gusset fold lines to form a completely sealed liquid carrying container bottom edge.

31. An adapter for connecting a face mask tube extending from a face mask and having a face mask tube connector valve secured to the end of the face mask tube for connecting the face mask tube to a source of liquid to a liquid carrying container having a closure which includes a push-pull element operable between a closed position to prevent liquid from flowing from the liquid carrying container and an open position to dispense liquid from the liquid carrying container through the push-pull element, comprising:
an elongate adapter body forming a face mask tube connector valve receiver at one end of the adapter body for receiving and opening the face mask tube connector valve; and
a push-pull element receiver formed at the other end of the body for receiving and operating the push-pull element of the liquid container closure whereby liquid from the liquid carrying container can be dispensed from the liquid carrying container through the push-pull element, the adapter, and the face mask tube connector valve to the face mask tube.

32. An adapter for connecting a face mask tube connector valve to a liquid container having a push-pull element operable between a closed position and an open position according to claim 31, wherein the push-pull element has a flange extending from the push-pull element, and wherein the push-pull element receiver fits tightly over the push-pull element flange so movement of the adapter with respect to the liquid carrying container closure causes operable movement of the push-pull element.

33. An adapter for connecting a face mask tube connector valve to a liquid container having a push-pull element operable between a closed position and an open position according to claim 32, wherein the face mask tube connector valve is a normally closed valve and the face mask tube connector valve receiver includes a cylindrical tube therein which interfaces with the face mask tube connector valve to open the face mask tube connector valve when the face mask tube connector valve is inserted into the face mask tube connector valve receiver.

34. An adapter for connecting a face mask tube connector valve to a liquid container having a push-pull element operable between a closed position and an open position according to claim 33, wherein the end portion of the cylindrical tube which interfaces with the face mask tube connector valve to open the face mask tube connector valve includes an end portion having a plurality of grooves therein through which liquid can pass when the face mask tube connector valve is inserted into the face mask tube connector valve receiver.
